(19) United States
(12) Patent Application Publication
(10) Pub. No.: US 2026/0072739 A1
(43) Pub. Date: Mar. 12, 2026

(54) System And Method For Compute-Offloading Using A Storage Node

(71) Applicant: Oracle International Corporation, Redwood Shores, CA (US)

(72) Inventors: Weiwei Gong, Los Altos (CA); Periklis Chrysogelos, Zurich (CH); Pedro Paulo de Souza Bento da Silva, Berlin (DE); Yifan Gan, Seattle, WA (US); James Kearney, Bolton, MA (US); Shasank Kisan Chavan, Menlo Park, CA (US)

(21) Appl. No.: 19/320,733

(22) Filed: Sep. 5, 2025

Related U.S. Application Data
(60) Provisional application No. 63/692,091, filed on Sep. 7, 2024.

(51) Int. Cl. G06F 9/50

(52) U.S. Cl. CPC G06F 9/5005; G06F 9/5083; G06F 2209/505; G06F 2209/509

(57) ABSTRACT

A database system compiles an execution plan to generate a compute-offload plan for execution by a compute-offload runtime. The compute-offload plan specifies a set of tasks to be offloaded and metadata specifying resource binding parameter values, associating a set of data items stored in one or more storage nodes with the set of tasks. Executing the compute-offload plan comprises sending, using a first communication path, the set of tasks and the resource binding parameter values from the database system to a compute-offload cluster; transferring, using a second communication path, the set of data items from the storage nodes to offload execution nodes based on the resource binding parameter values; and executing the set of one or more tasks on the offload execution nodes to process the set of data items.

### BENEFIT CLAIM

This application claims the benefit of Provisional Application 63/692,091, filed Sep. 7, 2024, the entire contents of which are hereby incorporated by reference as if fully set forth herein, under 35 U.S.C. § 119(e).

### TECHNICAL FIELD

The present disclosure relates to a compute-offloading framework and, more particularly, to providing an effective and flexible solution to offloading compute-intensive workloads and requests from a database system.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

Data-intensive and compute-intensive queries (e.g., analytical, graph processing, vector index creation) often appear in spikes. The performance of these queries is sensitive to the underlying hardware. As a result, proper provisioning of the database cluster, both in terms of the number of machines and their types (e.g., memory or compute capabilities and size), is important to performance. However, the spikes make effective provisioning of the database cluster challenging.

In terms of cluster size, statistically sizing a database cluster can lead to either (1) a waste of resources when trying to provision for the spikes, as the cluster is oversized in the absence of such spikes, or (2) unnecessarily slow execution of such data- or compute-intensive queries, when the cluster is provisioned ignoring the potential spikes. In contrast to static cluster sizes, dynamic clusters change the number of nodes in the cluster. However, typically, the new nodes are similar in shape to the pre-existing nodes, and they are only picked up by the next queries and not currently executing queries. Furthermore, dynamically adjusting the cluster size assumes predictable data and compute patterns (e.g., periodic warehouse maintenance queries or batches of queries). However, many exploratory or user-generated queries are difficult to predict.

In terms of machine types in the cluster, the hardware is typically predetermined and statically provisioned by an administrator far before processing spiky queries. Furthermore, the database cluster is typically homogenous, or there are few machine types statically assigned to specific node types. For example, either all the machines have the same shape, or they are separated into a few categories (e.g., compute and storage machines), with each executing a specific part of the query.

Moreover, when offloading part of a query (i.e., a subquery) to nodes that do not belong to the database cluster, the subquery is typically extracted and submitted as a standalone query to the remote nodes. This imposes result materialization and conversion overheads and limits load-balancing, because an offloaded query often statically defines what data will be processed by each node.

### BRIEF DESCRIPTION OF THE DRAWINGS

In the drawings:

FIG. 1 depicts a compute offloading framework in accordance with an embodiment.

FIG. 2 depicts a compute offloading framework between a database system, a storage system, and a compute-offload server cluster in accordance with an embodiment.

FIG. 3 depicts a compute-offload runtime and plan compilation, execution, and coordination in accordance with an embodiment.

FIG. 4 is a block diagram illustrating the use of virtual connection groups and inter-task queues for coordinating offload execution in accordance with an embodiment.

FIG. 5 illustrates an example SQL plan with a rowsource for governing compute-offload processing in accordance with an embodiment.

FIG. 6A depicts an example parallel statement queueing plan with two-level joins and aggregation with compute offload disabled in accordance with an embodiment.

FIG. 6B depicts an example parallel statement queueing plan with two-level joins and aggregation with compute offload enabled in accordance with an embodiment.

FIG. 7A illustrates a transformation example for operator conversion in accordance with an embodiment.

FIG. 7B illustrates a conversion of operators based on the predefined rules in accordance with an embodiment.

FIG. 7C illustrates a transformation example for annotating memory lifetime and deallocation in accordance with an embodiment.

FIG. 7D illustrates a transformation example for buffer optimization in accordance with an embodiment.

FIG. 8 is an entity/relationship diagram for plan execution in accordance with an embodiment.

FIG. 9 depicts an example of dividing a plan into pipelines in accordance with an embodiment.

FIG. 10 illustrates an example pipeline consisting of tasks in accordance with an embodiment.

FIG. 11 illustrates an example task in accordance with an embodiment.

FIG. 12 is a diagram illustrating task-to-microtask scheduling for a compute-offload plan in accordance with an embodiment.

FIG. 13 illustrates task-based scheduling using inter-task queues in accordance with an embodiment.

FIG. 14 illustrates inter-task queue operations in accordance with an embodiment.

FIG. 15A illustrates mapping operators to high-performance kernel functions inside a pipeline in accordance with an embodiment.

FIG. 15B illustrates extracting asynchronous regions to tasks inside a pipeline in accordance with an embodiment.

FIG. 15C illustrates a microtask enqueueing to another microtask inside a pipeline in accordance with an embodiment.

FIG. 15D illustrates multi-task dependencies inside a pipeline in accordance with an embodiment.

FIG. 15E illustrates parallel microtask versus serial task execution inside a pipeline in accordance with an embodiment.

FIGS. 16A and 16B are data flow diagrams illustrating inter-task queue and virtual connection group messaging in accordance with an embodiment.

FIG. 17 illustrates compute offload on a storage cell in accordance with an embodiment.

FIG. 18 is a flowchart illustrating compiling an execution plan for compute offload with fallback in accordance with an embodiment.

FIG. 19 is a flowchart illustrating executing an offload-enabled execution plan in accordance with an embodiment.

FIG. 20 is a flowchart illustrating executing a logical task in accordance with an embodiment.

FIG. 21 is a block diagram that illustrates a computer system upon which the embodiments may be implemented.

FIG. 22 is a block diagram of a basic software system that may be employed for controlling the operation of a computer system in accordance with an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

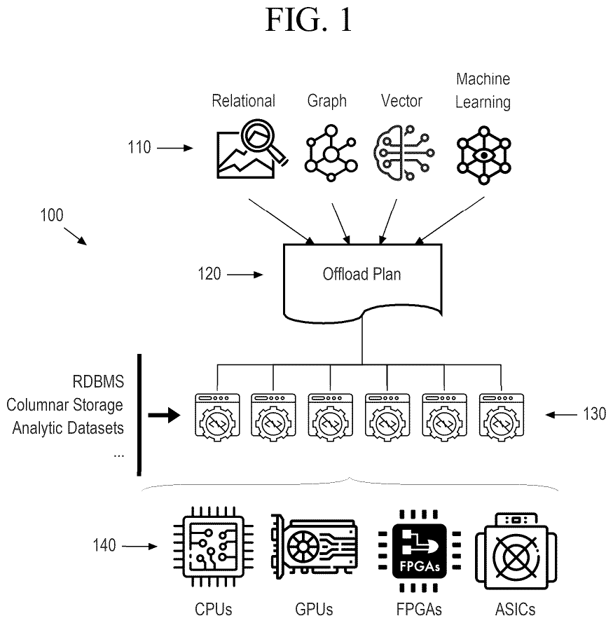

The illustrative embodiments provide a compute-offload server that is a generic compute offloading framework. The framework aims to provide a cost-effective and flexible solution to offload compute-intensive workloads and requests from a database server, such as a relational database management system (RDBMS). FIG. 1 depicts a compute offloading framework 100 in accordance with an embodiment. The compute offloading framework attempts to achieve the following goals:
1. Performance: The compute offloading framework 100 leverages modem hardware 140 for efficient execution.
2. Scalability: The compute offloading framework 100 can scale up, scale out, and parallelize across cores and nodes.
3. Flexibility: The compute offloading framework 100 makes it easy to convert a compute-intensive workload 110 into an offload-enabled plan 120 that can be run at any supported platform anywhere. In some embodiments, the offload-enabled plan 120 is just-in-time (JIT) executable, thus providing portability and transportability. In other embodiments, the offload-enabled plan 120 may be pre-compiled and part of the RDBMS/offload-server binaries. The compute-offload server can support relational queries, graph queries (both property graph and PGX.D), and vector similarity search (e.g., index creation and embedding generation). In other embodiments, the compute-offload server can be extended to support other types of workloads.
4. Elasticity: The compute offloading framework 100 can dynamically provision nodes 130 as requests come.
5. Extensibility: The compute offloading framework 100 can be extended to easily support different data formats besides those in an RDBMS, such as open-source column-level data formats, language-independent column-level data formats, and open table formats.
6. Heterogeneity: The compute offloading framework supports various hardware platforms 140, such as central processing unit (CPU), graphics processing unit (GPU), field programmable gate arrays (FPGAs), application-specific integrated circuits (ASICs), etc.

The compute offloading framework of the illustrative embodiments allows for fine-grained compute-offload. The database engine decides which parts of the query to offload and constructs an offload-enabled plan detailing how the offload will execute, i.e., which operations will be executed in the remote nodes. In some embodiments, the offload-enabled plan 120 is not a tree of operations, which is the de-facto form of an execution plan for a database instance, but instead is an offload program. This program details the micro-operations that will run to execute the offloaded plan on the remote nodes and how they will be parallelized or distributed. However, the offload-enabled plan 120 does not specify the number of nodes, which can be determined dynamically at runtime.

The compute offloading framework of the illustrative embodiments allows two-level partitioning. Typically, the number of partitions is tightly coupled to either the number of machines or the number of cores. This imposes limitations both in changing this during runtime, as well as in using a heterogeneous set of machines for executing the query (as existing approaches aim for approximately equally sized partitions and, thus, using heterogeneous resources would introduce unwanted skew). In the illustrative embodiments, the two concepts are decoupled such that (1) one or more machines may be working on the same partition, and (2) one machine may be working on one or more partitions. This means that the number of machines working on a partition during runtime can be scaled independently of the rest of the partitions. Partitions are characterized by a data-dependent key and partitioned data structures, while multiple workers working on a partition get different inputs but access to the same partition of a data structure (i.e., the data structure partition is either shared (shared memory) or replicated/broadcasted across machines).

The compute offloading framework of the illustrative embodiments provides pipelined execution to determine the number and/or types of offload nodes. Pipeline execution has been used to avoid materialization of intermediary data and has been used for load balancing over heterogeneous devices; however, the compute offloading framework of the illustrative embodiments exploits pipeline execution to elastically determine the number of instances to assign per partition and thus facilitate elastic runtime scaling to machines based on the observed query performance.

The compute offloading framework of the illustrative embodiments provides semi-stateful execution. Tasks may maintain some task-local state across inputs of the same query (for performance). Multiple instances of this state can be instantiated so that multiple workers work on the same task concurrently. When a worker processes an input for a task, it gets exclusive access to one of the task-local states for this task. To facilitate elasticity, task-local states can be created or destroyed at any time, even after some inputs for this task have been processed. Creating new states is equivalent to increasing the number of concurrent workers available for a task, while destroying new states is equivalent to reducing the workers available for this task. Workers (e.g., threads) may be ready to pick up work for any task, independently of whether there is some task-local state available.

The compute offloading framework of the illustrative embodiments provides a plan that is specialized for offload. The offload plan may contain annotations about what type of memory to allocate as the output of different operations. Specifically, for high-performance networking as well as for fast data transfers between host CPUs and accelerators, participating memory often must be allocated from specific pools or registered with accelerator-specific utilities. The offload plans may annotate the allocations contained in the plan as preferring specific memory pools or wanting registrations to avoid unnecessary staging or using suboptimal memory.

The compute offloading framework of the illustrative embodiments also provides skew-tolerant hybrid execution. Fine-grained data is distributed among the database nodes as well as the offloading nodes with different compute capabilities. At each parallelization domain of the execution, data is re-distributed based on the current status to better handle data skew and processing skew.

The compute offloading framework of the illustrative embodiments also allows for dynamic fallback. Not all operations may be worth offloading, or the available resources may not be sufficient or worth the offload effort. A decision is made to fall back when there are no available resources or when higher-priority requests compete for the resources. The decision may occur in the beginning or may occur dynamically during the execution of the offloading request. To facilitate such cases, there are two fallback modes: one where the offload scales down to use only the original database cluster resources allowed for the query, and one that completely falls back to the preexisting implementation.

The compute offloading framework of the illustrative embodiments improves cost efficiency. The cost of executing a query depends on the underlying hardware. The embodiment allows dynamically assigning the underlying hardware to each query; therefore, it allows for fast and dynamic (i.e., during runtime) selection of the appropriate hardware to optimize the price/performance tradeoff for each query. This enables lower prices that match the observed workload rather than prices that are based on worst-case provisioned resource requirements.

The compute offloading framework of the illustrative embodiments improves elasticity. Typically, system administrators must statically define the cluster resources; however, idle resources are a necessary cost without any return value other than gracefully handling unexpected spikes. The compute offloading framework of the illustrative embodiments allows the system to expand to cloud resources to handle the demand without imposing an operational cost when the resources are not required.

The compute offloading framework of the illustrative embodiments improves performance. The compute offload framework of the illustrative embodiments allows query execution to expand to more machines and thus accelerate query execution. Furthermore, it uses native formats and a fine-grained representation for which part of the query is offloaded, avoiding unnecessary costs when offloading parts of a query to remote nodes.

The compute offload framework of the illustrative embodiments also improves the ease of development. The same framework can be used for both efficient scale-up and scale-out execution, thus reducing the implementation burden and improving development and maintainability.

### Compute Offloading Framework

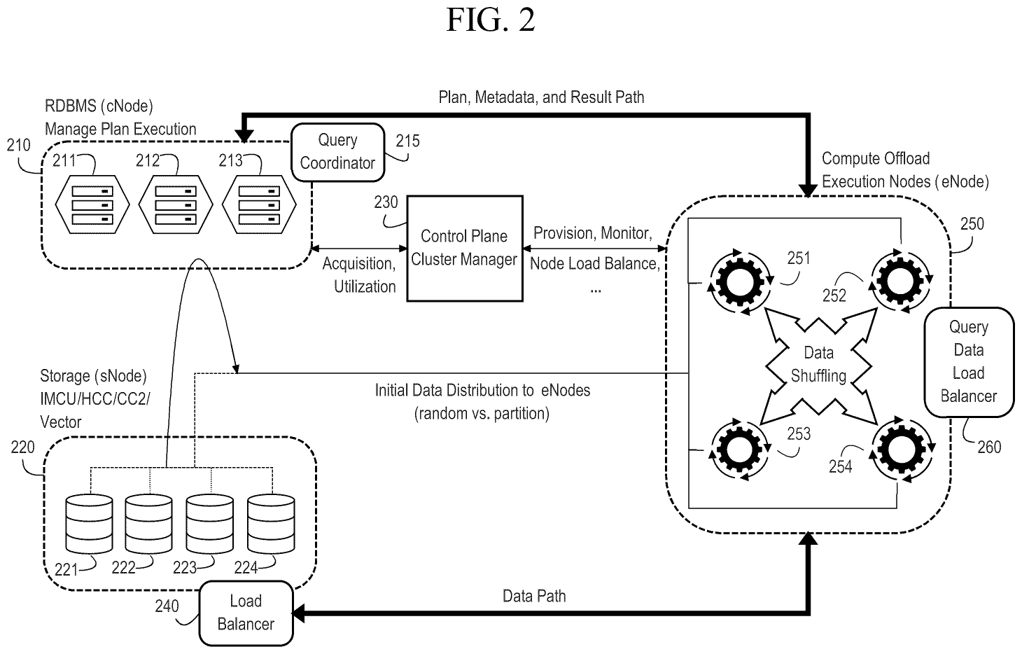

FIG. 2 depicts a compute offloading framework between a database system 210, a storage system 220, and a compute-offload server cluster 250 in accordance with an embodiment. There are three different actors in the framework: database compute nodes (cNodes) 211-213, storage nodes (sNodes) 221-224, and compute-offload execution nodes (eNodes) 251-254. The number of cNodes, sNodes, and eNodes will vary depending on the implementation. Database compute nodes (cNodes) 211-213 run in a database system 210, such as a relational database management system (RDBMS). The embodiments will be described with respect to an RDBMS; however, the queries and workloads may include queries and workloads that do not operate on relational database tables, such as graph queries and vector processing. Queries and workload requests are received at the RDBMS 210. Compute offload is transparent to the user submitting the query or workload. The user is unaware of what work is performed by the RDBMS 210 or offloaded to the compute-offload server cluster 250.

In the most common cases, data is stored entirely within storage system 220. However, it is possible for some data to exist in the RDBMS 210, such as in-memory compression units (IMCUs), which are logical units of storage within an in-memory column store. It is also possible for a cNode and an sNode to be combined into one node, such as implementations of an in-memory database. In general, the storage system 220 can exist anywhere, and the RDBMS 210 fetches data from storage system 220 for non-offloaded execution. In some embodiments, storage nodes 221-224 store data as IMCU format, hybrid columnar compression (HCC) format, CC2 format (an in-memory format that allows loading row format blocks and HCC format blocks), vector data formats, and other data formats.

The compute-offload server cluster 250 includes eNodes 251-254, which can communicate with RDBMS 210 using a first communication path and with storage system 220 using a second communication path. RDBMS 210 includes query coordinator 215, which generates an offload-enabled execution plan, as will be described in further detail below. RDBMS 210 communicates the offload-enabled plan and metadata describing the data on which to execute to the compute-offload server cluster 250 via the first communication path. The eNodes 251-254 can access the data on sNodes 221-224 via the second communication path. The eNodes 251-254 can then return results to RDBMS 210 via the first communication path.

Storage system 220 has a load balancer 240 for distributing data to eNodes 251-254 for query or workload processing. Ideally, sNodes 221-224 can communicate to eNodes 251-254 directly using the second communication path. In some embodiments, sNodes 221-224 can use cNodes 211-213 as a proxy, loading data into the RDBMS 210 and then distributing data to eNodes 251-254. Storage system 220 can distribute data to the eNodes using a random distribution or using partitioning. Storage system 220 uses load balancer 240 to ensure that the initial data distributed to the eNodes is balanced.

Offload execution in the compute-offload server cluster 250 can have stages, and at each stage, data skew can occur. In other words, while the initial data distribution may be balanced, there may be data skew in the results of a given execution stage. For example, a query may involve a many-to-many join. It is likely that one join may produce a larger result set than another join and, thus, one eNode may host more result data than another eNode. Compute-offload server cluster 250 includes internal load balancer 260, which performs data shuffling among eNodes 251-254. Internal load balancer 260 monitors what is happening in compute-offload server cluster 250 and attempts to balance data among the eNodes as much as possible. Data shuffling may also be performed in response to eNodes being added to or removed from compute-offload server cluster 250.

Assignment of work to eNodes is elastic and dynamic. Data does not remain on an eNode after execution. The sNodes transfer data ad hoc, and eNodes discard data when execution is finished. The eNodes only temporarily host the data during execution.

Query coordinator 215 determines which portions of a query or workload are offloaded. For example, sNodes 221-224 may be Oracle® Exadata storage nodes capable of performing some operations at the storage node that achieve improved performance when performed at the data site (e.g., Exadata Smart Scan). Thus, some operations may be performed by the cNodes 211-213, some operations may be performed by the sNodes 221-224, and compute-intensive operations may be offloaded to eNodes 251-254.

In some embodiments, the compute offloading framework can allow for resource sharing between different instances of RDBMS 210. Control plane cluster manager 230 can perform acquisition and utilization operations to assign resources from the compute-offload server cluster 250 to perform offload execution for each instance of RDBMS 210. Control plane cluster manager 230 performs provisioning, monitoring, node load balancing operations, etc. Therefore, control plane cluster manager 230 ensures there are sufficient offload execution eNodes for multiple instances of RDBMS 210. Control plane cluster manager 230 communicates this information back to RDBMS 210 so the cNodes 211-213 know how to best use eNodes 251-254.

### Runtime, Compilation, and Fallback

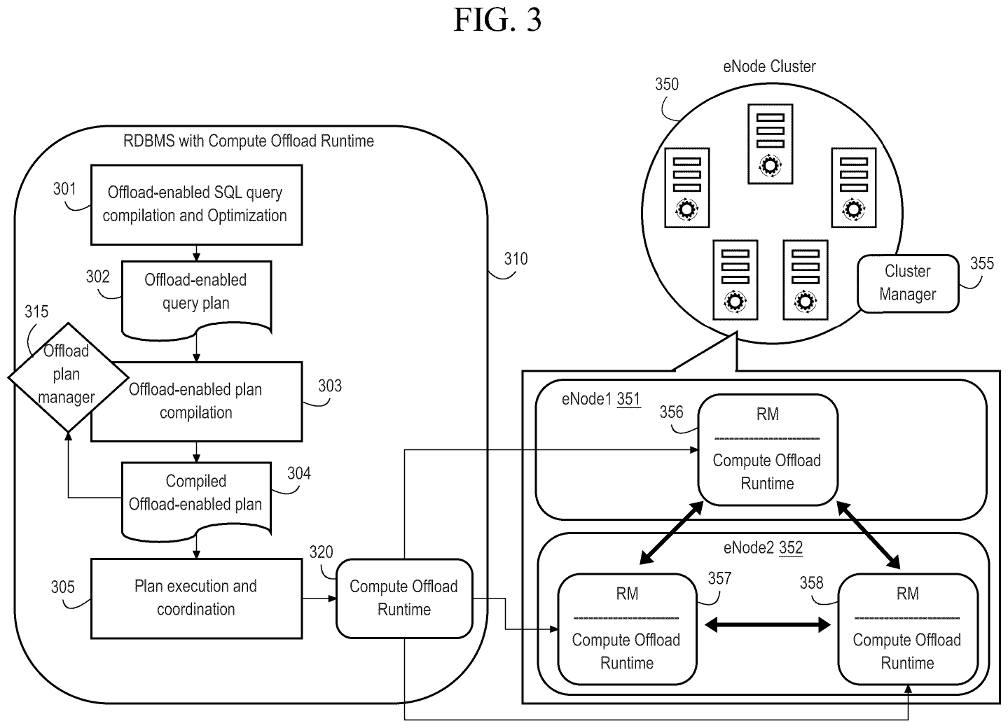

FIG. 3 depicts a compute-offload runtime and plan compilation, execution, and coordination in accordance with an embodiment. RDBMS 310 includes a compute-offload runtime 320. The RDBMS 310 performs offload-enabled query compilation and optimization (block 301). RDBMS 310 receives a query, such as a structured query language (SQL) query in this example, and normally performs compilation and optimization to generate an execution plan. In accordance with the embodiment, the RDBMS performs compilation and optimization to generate an offload-enabled plan 302 that can be further compiled for execution on the compute-offload runtime.

RDBMS 310 then performs offload-enabled plan compilation (block 303) to generate a compiled offload-enabled plan 304. Compilation in block 303 is not inconsequential. Therefore, it would be preferable to avoid compilation in block 303 if it is possible. Offload plan manager 315 attempts to reuse past compilations, which can be stored in a cache (not shown). As will be described in further detail below, portions of a plan can be divided into pipelines, each of which has a pipeline template and a resource binding. The pipeline templates can be compiled and cached. Thus, offload plan manager 315 can look up (e.g., a hash lookup) portions of a plan to determine if a compiled pipeline template already exists for the portion of the plan. These cached pipeline templates can be reused and assigned different resource bindings. For example, a pipeline for scanning a table or a pipeline for a join on a single join key could be compiled and cached for later reuse. Pipelines and pipeline templates will be described in further detail below.

RDBMS 310 then performs plan execution and coordination of the compiled offload-enabled plan 304 (block 305). In block 305, RDBMS 310 executes the compiled offload-enabled plan 304 and coordinates execution using compute-offload runtime 320, which exists in one or more cNodes of RDBMS 310, and using eNodes 351, 352 of eNode cluster 350.

Compute-offload runtime 320 is a library that exists in one or more cNodes of RDBMS 310. In some embodiments, eNode1 351 runs a resource management (RM) and compute-offload runtime 356, and the eNode2 352 runs resource management and compute-offload runtime 357 and resource management and compute-offload runtime 358. Compute-offload runtime 320 communicates with and coordinates the remote compute-offload runtimes 356-358.

Multiple eNodes can be provisioned on the same physical host. The configuration of eNodes on physical hosts may depend on how the hardware resources are used. For example, each physical host may be a two-socket machine where system memory is divided into cells or nodes associated with particular CPUs. Each socket and directly attached random-access memory (RAM) is a node. The CPU and local memory are referred to as a non-uniform memory access (NUMA) node. There are two ways to provision such a machine: one is to host an eNode on a NUMA node, and the other is to host a single eNode that uses both NUMA nodes.

Compute-offload server cluster 350 includes cluster manager 355, which manages cluster membership, monitors node health, and monitors resource utilization.

Note that RDBMS 310 includes compute-offload runtime 320 and has cNodes for performing work. It is possible that a candidate offload region being executed by the compute-offload runtime can be entirely executed by the compute-offload runtime 320 within the RDBMS 310 without involving eNodes. This may be referred to as “onloading.” However, in most cases, executing an offload-enabled plan using the compute-offload runtime will involve hardware resources in compute-offload server cluster 350, such as eNode1 351 and eNode 2 352 in FIG. 3. This will require coordination between compute-offload runtime 320 and the compute-offload runtimes 356-357 in the compute-offload server cluster 350.

### Virtual Connection Group and Inter-Task Queues

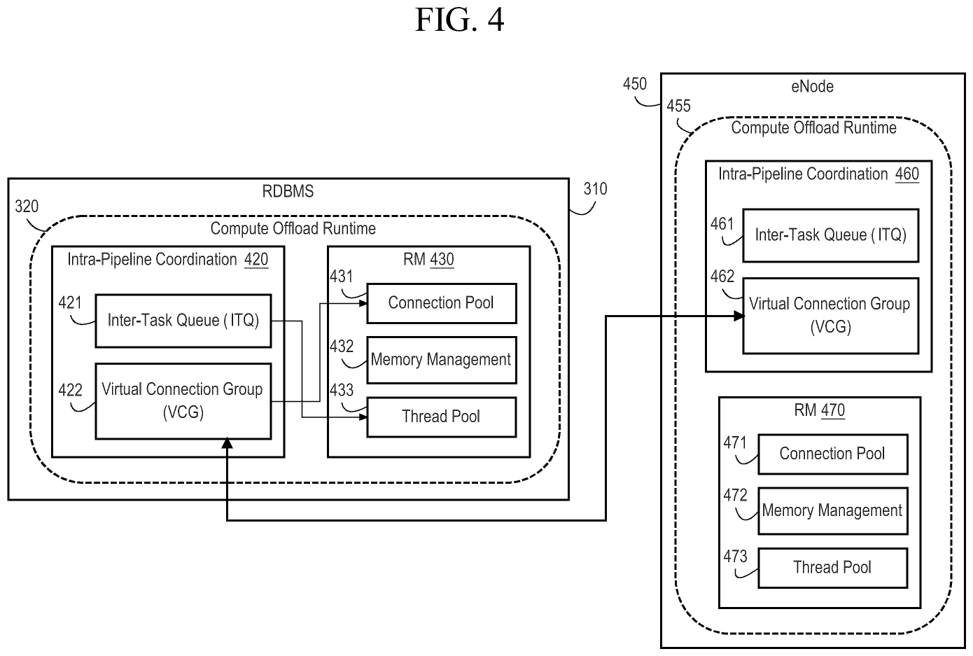

FIG. 4 is a block diagram illustrating the use of virtual connection groups and inter-task queues for coordinating offload execution in accordance with an embodiment. In block 301 of FIG. 3, the RDBMS 310 detects an offload candidate query and generates a new rowsource for an offloadable row source region. The RDBMS checks the availability of the cluster and determines whether it will attempt to offload. If the RDBMS attempts to offload, then the RDBMS determines whether it will use a single node or multiple nodes (i.e., not how many nodes). The RDBMS then compiles the offload-enabled SQL plan 302 to generate the compiled offload-enabled plan 304.

Execution in block 305 includes offload-enabled rowsource execution. The RDBMS sends plan pipelines and coordinates inter-pipeline execution. The RDBMS waits for task completion. The RDBMS also performs dynamic load balancing. Execution in block 305 also opens plan pipelines, creates virtual connection group (VCG) connections, if needed, and sends the data while scanning tables with a plan pipeline identifier using the VCG.

As shown in FIG. 4, Compute-offload runtime 320 includes intra-pipeline coordination 420 and resource management 430. One or more inter-task queues (ITQs) 421 track multiple task executions within a pipeline, maintain the task context for all task threads, and schedule task executions based on availability and dependencies. The VCG 422 encapsulates local versus remote nodes and hides underlying network communication. Resource management 430 includes connection pool 431, memory management 432, and thread pool 433. In RDBMS 310, ITQ 421 can assign work to thread pool 433. VCG 422 uses connection pool 431 to communicate with eNode 450.

In eNode 450, compute-offload runtime 455 includes intra-pipeline coordination 460 and resource management 470. One or more inter-task queues (ITQs) 461 track multiple task executions within a pipeline, maintain the task context for all task threads, and schedule task executions based on availability and dependencies. The VCG 462 encapsulates local versus remote nodes and hides underlying network communication. Resource management 470 includes connection pool 471, memory management 472, and thread pool 473. In eNode 450, ITQ 461 can assign work to thread pool 473. VCG 462 uses connection pool 471 to communicate with RDBMS 310.

### Offload-Enabled Plan

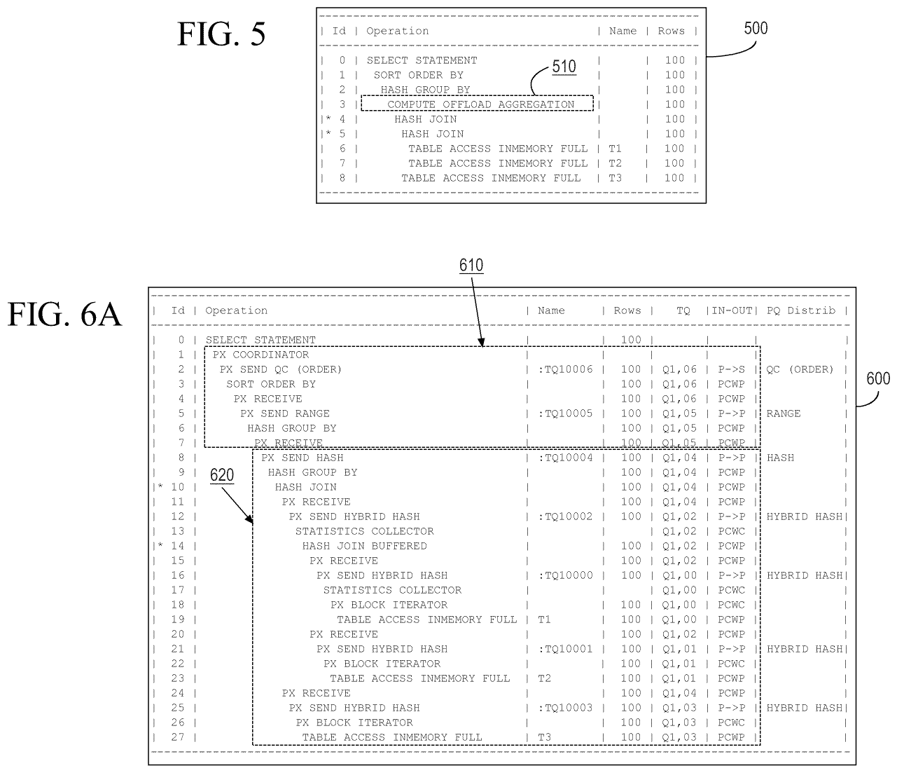

FIG. 5 illustrates an example SQL plan with a rowsource for governing compute-offload processing in accordance with an embodiment. FIG. 5 shows a serial plan with a two-level join and aggregation with an added rowsource (COMPUTE OFFLOAD AGGREGATION) that governs the entire compute-offload processing, indicating an offloading candidate region starting with the HASH JOIN statement in line 4. In the example, the rowsource is shown as “COMPUTE OFFLOAD AGGREGATION” 510; however, the name of the rowsource will depend on the implementation. In the example shown in FIG. 5, the rowsource includes aggregation because the parent in the SQL plan is a HASH GROUP BY, which is an aggregation.

When an offload-enabled plan is generated, there is no guarantee that offloading will be executed (e.g., due to resource limitations) or will be successful (e.g., fallback). An offloading region is a subset of query execution. The offloading candidate region is identified during query compilation time, and a new compute-offload rowsource 510 is inserted as a parent of the offloading subtree. For example, offloading candidate regions may include the following supported SQL operators: scan, join, granule iterator, bloom filter, graph, vector index create, embedding, etc. The new rowsource signals that the following region can be offloaded to the compute-offload runtime.

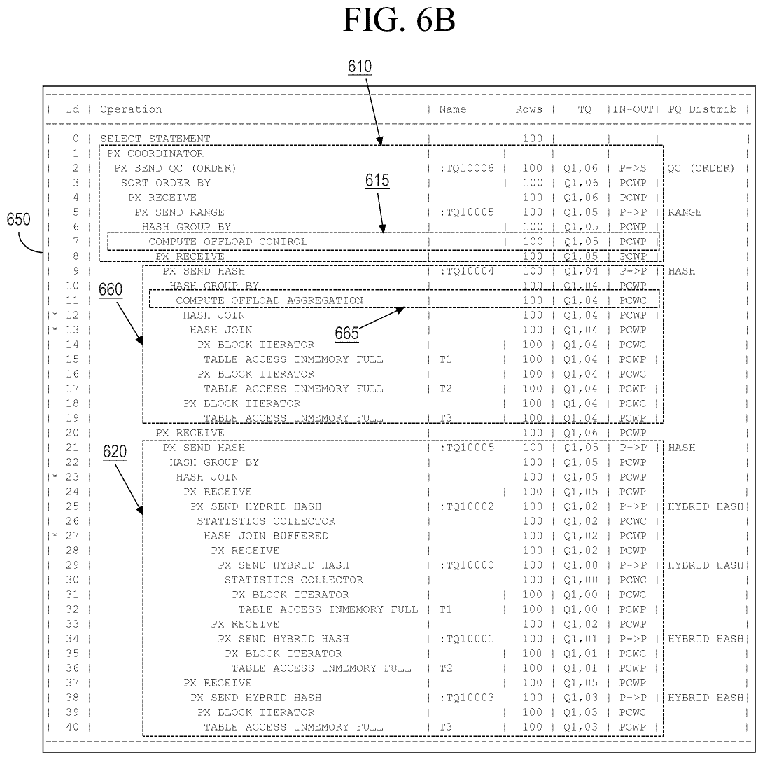

FIG. 6A depicts an example parallel statement queueing plan with two-level joins and aggregation with compute offload disabled in accordance with an embodiment. Execution plan 600 is a parallel statement queueing plan, also referred to as a parallel query (PQ) plan. Execution plan 600 includes a non-offloadable portion 610 and an offloadable portion 620.

FIG. 6B depicts an example parallel statement queueing plan with two-level joins and aggregation with compute offload enabled in accordance with an embodiment. Execution plan 650 is an offload-enabled plan generated by the RDBMS. As seen in the depicted example, the non-offloadable portion 610 is inserted into execution plan 650 with an added control 615 and portion 620 is inserted as a fallback branch. Execution plan 650 also includes a compute-offload branch 660, which includes the rowsource 665 that signals the region that can be offloaded to the compute-offload runtime. The compute-offload branch 660 is similar to the original portion 620 but is simplified to the block iterator and table access instructions. Thus, execution plan 650 includes control 615, compute-offload branch 660, and fallback branch 620.

The control 615 determines whether to execute the compute-offload branch 660 using the compute-offload runtime, execute the fallback branch 620, or abort execution. For example, the compute-offload server cluster may be down due to a crash, or there may be insufficient resources to achieve the benefit of compute offload. In these cases, control 615 may decide to execute the fallback branch 620 using the RDBMS without interrupt to the end user.

### Compute-Offload IR, Transformations, Compilation, and JIT Execution

In some embodiments, in order to generate a compute-offload plan, the RDBMS must generate a compute-offload intermediate representation (IR), perform transformations, and generate a just-in-time (JIT) executable plan. In other embodiments, the compute-offload plan may be pre-compiled. Intermediate representation (IR) is a representation of a program between the source and target languages. The compute-offload IR is a representation of offloaded queries, which can be low-level, typed, and platform-independent. In some embodiments, the compute-offload IR is composable with newly defined operators for the compute-offload runtime.

In some embodiments, the compute-offload IR is based on an acc(X)eleration, eLastic intermediate representation (XLIR). The XLIR representation is one example representation in one embodiment, but the name of the IR will depend on the implementation. In some embodiments, the XLIR is a multi-level intermediate representation (MLIR) dialect composed of operators. MLIR is part of the low-level virtual machine (LLVM) compiler infrastructure. MLIR is an intermediate representation and compiler framework for specifying IRs, lowering passes and rewrite rules, etc. The design pattern of multi-level transformations is from MLIR. The compute-offload IR provides a single representation for offloaded workloads. The compute-offload IR is reusable and composable. The same IR operations can be used across workloads. A plan is composed of IR operations of rowsources or operations. The compute-offload IR is self-contained and includes all necessary static information in an offload plan, including runtime tactics for adaptivity. The compute-offload IR is also expressive and optimizable because it includes information necessary for performance-optimized offloading.

The transformations gradually annotate, optimize, and lower the plan for optimized execution. Transformations are performed using a multi-level transformation pipeline. Optimizations happen at their preferred level of representation. Transformations use general and reusable passes or rules. Transformations are applicable across many operations and plans. The transformations can achieve a wide spectrum of optimizations from high-impact transformations to last-mile optimizations.

With JIT execution, the final offload-enable plan is directly executable. The coordination that is needed for the JIT plan is very lightweight. In some embodiments, the final plan is composed of mostly high-performance kernel and compute-offload runtime invocations. JIT code that is generated avoids interpretation by providing fast compilation to in-process memory. In other embodiments, the framework can invoke other utilities, such as functions from cuVS CAGRA libraries from NVIDIA for GPU-offload of vector index creation, for example. Also, the generation of the JIT plan is fully integrated into the RDBMS. The main code is unaware of the JIT code, and selected pre-prepared plans are part of the derived objects (DOs) (i.e., transformed and linked into the RDBMS libraries and executables during build time). In some embodiments, JIT execution is optional.

The offload-enabled plan is compiled and transformed with multi-level intermediate representation (MLIR) at the compute offload rowsource allocation time. In addition to rowsource allocation time, there may be a mode where static plans (i.e., plans written at development time, instead of being generated at runtime) are compiled and transformed during RDBMS compilation (source compilation, not query compilation). If the offloading cluster is unavailable at the time, the compilation is skipped, and the fallback non-offloading execution is performed. Domain-specific operations can be defined to form dialects (logical groups of operations). Compute offload defines the operators in MLIR TableGen with arguments, properties, serialization format, and non-standard hooks. MLIR converts declarative TableGen into C++ code and adds standard functions. Gradual lowering provides more fine-grained control for optimization, instead of from a domain-specific high-level description, directly to the machine code as one step. High-level dialects are more expressive. Multiple-level dialects can coexist.

In one embodiment, there are up to forty passes of transformations during the query compilation. Important ones include:
Break SQL plans into multiple pipelines, with high-level table and column metadata (e.g., join group), and optionally cache the PQ distribution decision.
Per-pipeline transformation, controlled by the compute offloading framework:
1. Logical operation mapping: make data structure distribution friendly, map symbolic operations to functions.
2. Parallelization: one pipeline could be broken down into n parallelization regions to allow distributed execution.
3. Extract asynchronous regions as tasks: each async-executable region is considered a task in the pipeline; dependencies exist between tasks.
4. Rewrite iterative operations: transform iterative operations (e.g., for_each_probe_match) to WHILE loops).
5. Explicit memory allocation/deallocation/reuse.
6. Conversion to coroutines: task can be suspended and resumed.
7. Canonicalization: minimize unnecessary conversion and remove duplications; may happen in multiple passes.
8. Lower to machine code.
Typically about 100-150 ms per pipeline compilation, and concurrent pipelines compilation with multi-thread.
   Transformations 1-6 above are compute-offload specific. Transformations 7 and 8 above are generic in MLIR.

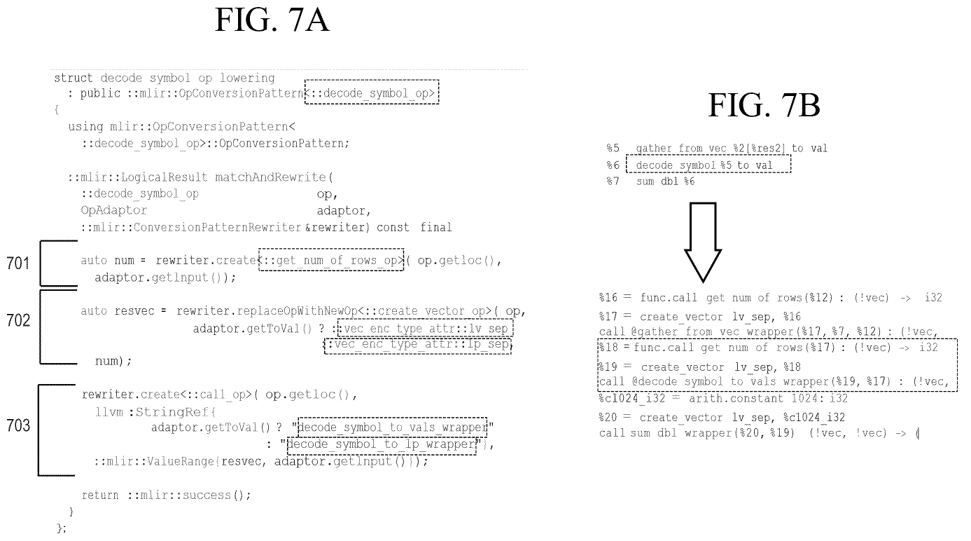

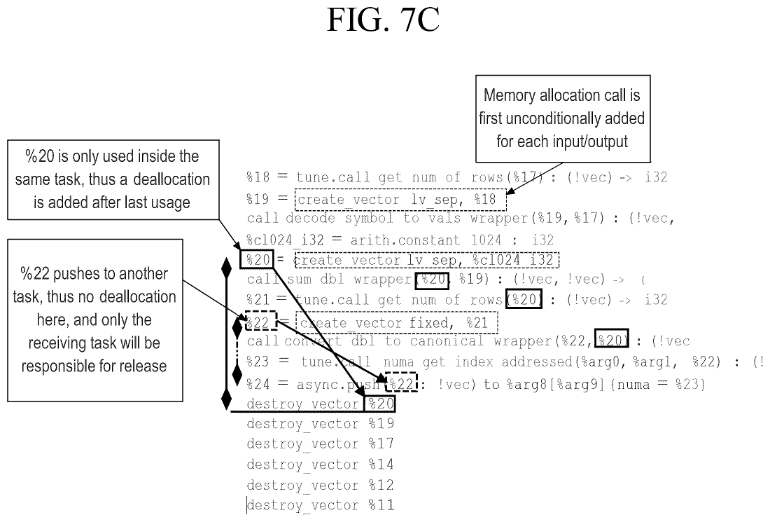

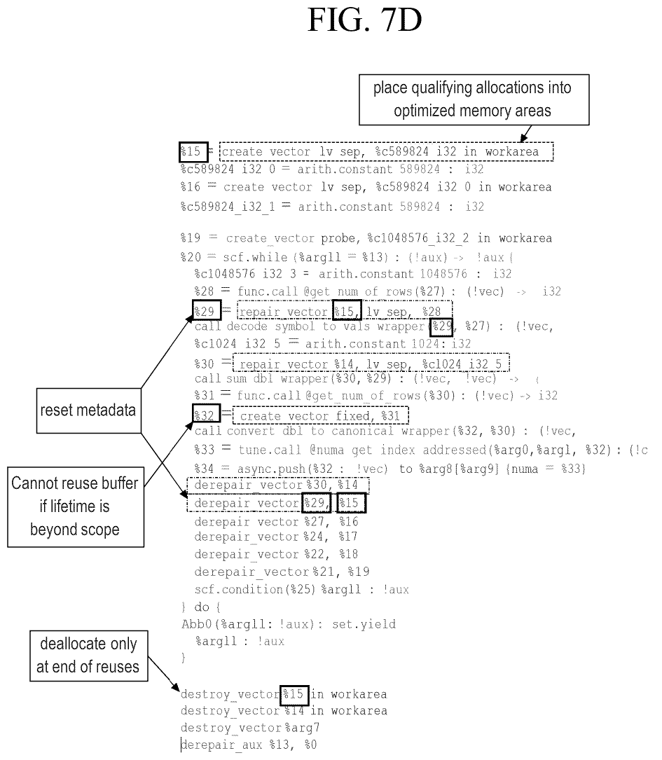

FIG. 7A illustrates a transformation example for operator conversion in accordance with an embodiment. FIG. 7A illustrates rules 701, 702, 703 that are predefined for an operator <::decode_symbol_op>. FIG. 7B illustrates a conversion of operators based on the predefined rules in accordance with an embodiment. In this example, the portion of code including the <::decode_symbol_op> operator in the top portion of FIG. 7B is converted to the code in the bottom portion of FIG. 7B using the predefined rules from FIG. 7A.

FIG. 7C illustrates a transformation example for annotating memory lifetime and deallocation in accordance with an embodiment. A memory allocation call is first unconditionally added for each output. The % 20 create vector is used only inside the same task; therefore, the transformation adds a deallocation after the last usage (destroy_vector % 20). However, the % 22 create vector pushes to another task; therefore, the transformation does not add a deallocation for % 22. Only the receiving task is responsible for releasing the memory allocation.

FIG. 7D illustrates a transformation example for buffer optimization in accordance with an embodiment. This transformation attempts to reuse memory as much as possible. The example shown in FIG. 7C included three create vectors for % 19, % 20, and % 22. This example also includes a create vector for % 15 that places qualifying allocations into optimized memory areas. The transformation can reset metadata and deallocate only at the end of use. There are instances where a buffer cannot be reused if its lifetime is beyond the scope.

### Pipelines, Logical Tasks, and Microtasks

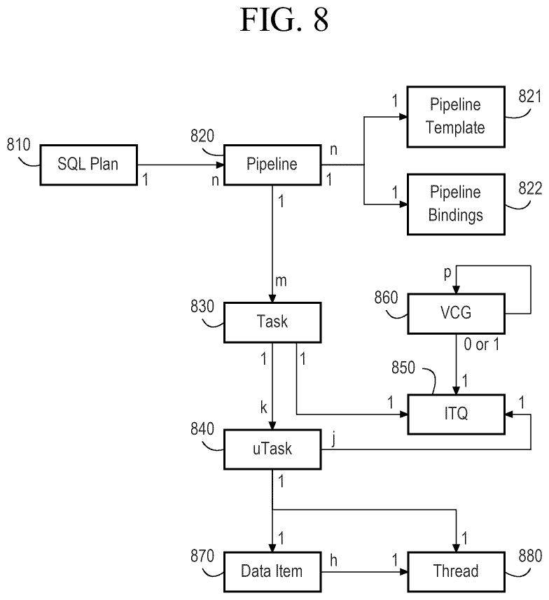

FIG. 8 is an entity/relationship diagram for plan execution in accordance with an embodiment. In the depicted example, the entity/relationship (ER) diagram is shown for SQL plan 810, which is broken down into n pipelines. Each pipeline is from a pipeline template 821 with its corresponding binding parameter values 822. Pipeline templates are reusable within a query and across queries managed by the compute-offload plan manager; therefore, there may be one template for g pipelines. Thus, each pipeline template 821 can be cached and used with different pipeline bindings 822.

Each pipeline 820 is further broken down into m Tasks. A Task is a logical entity, sometimes referred to herein as a “logical task,” which is a piece of code manipulating data and invoking a sequence of functions or other utilities or functions. A Task can perform the same function on multiple data items. Each instantiation of Task 830 for a given data item is referred to as a microtask (uTask). Each uTask 840 is an instantiated Task, processing a data item 870 and executing on a thread 880. Thus, each Task 830 can have k uTasks 840. There is a one-to-one correspondence between uTasks 840 and data items 870, and h data items can be processed by one thread 880. A thread may work on multiple uTasks, and a uTask is picked by exactly one thread.

There is one inter-task queue (ITQ) 850 per Task 830. An ITQ hosts multiple (j) uTasks 840 for one specific task Task 830. ITQ 850 checks for dependency between tasks. A uTask can be sent via a virtual connection group (VCG) 860 for remote run. An ITQ has 0 or 1 VCGs. A VCG has exactly one ITQ (not counting shadow ITQs). A node in VCG 860 is connected with multiple (p) nodes in the same VCG. There is a one-to-one correspondence between the ITQ 850 and the VCG 860. The VCG 860 hides the complexity of whether a Task is executed locally or remotely.

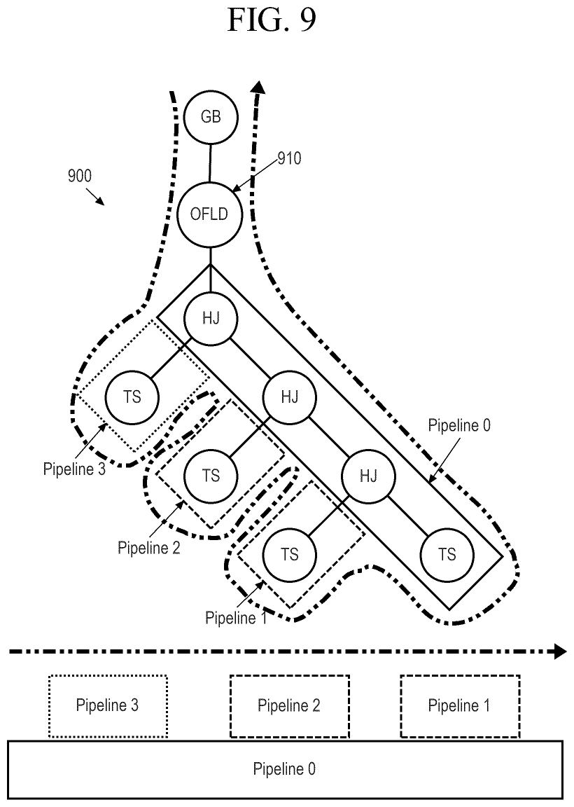

FIG. 9 depicts an example of dividing a plan into pipelines in accordance with an embodiment. Diagram 900 illustrates the operations for the following SQL query:
SELECT SUM(a)
FROM B1, B2, B3, P
WHERE . . .
GROUP BY GB
   This diagram includes nodes for table scans (TS), hash joins (HJ), an offload node 910, which refers to the “COMPUTE OFFLOAD AGGREGATION” rowsource 510 in FIG. 5, and group by (GB). Pipeline 1, pipeline 2, and pipeline 3 are for doing a table scan and building a hash table for one of the joins. Pipeline 0 is for doing a table scan and performing a probe on the hash tables built by pipeline 1, pipeline 2, and pipeline 3. In some embodiments, a pipeline starts with a scan and pushes data up as far as it can go without stopping.

As mentioned above, a pipeline is a pipeline template plus binding values. In the depicted example, pipeline 1 and pipeline 2 match their pipeline templates but have different placeholder values (resource bindings). That is, pipeline 1 and pipeline 2 may build a hash table with the same number of join keys and project the same number of columns. Thus, the pipeline template will only have to be compiled once for pipeline 1 and pipeline 2. Pipeline 3 does not use the same pipeline template as pipeline 1 and pipeline 2. For example, pipeline 3 may build a hash table with a different number of join keys or may project a different number of columns.

The binding values allow the pipeline templates to be identical while using different binding values to refer to the data, such as different table identifiers and columns. This allows similar code referencing different data to map to the same pipeline template, i.e., a cache hit.

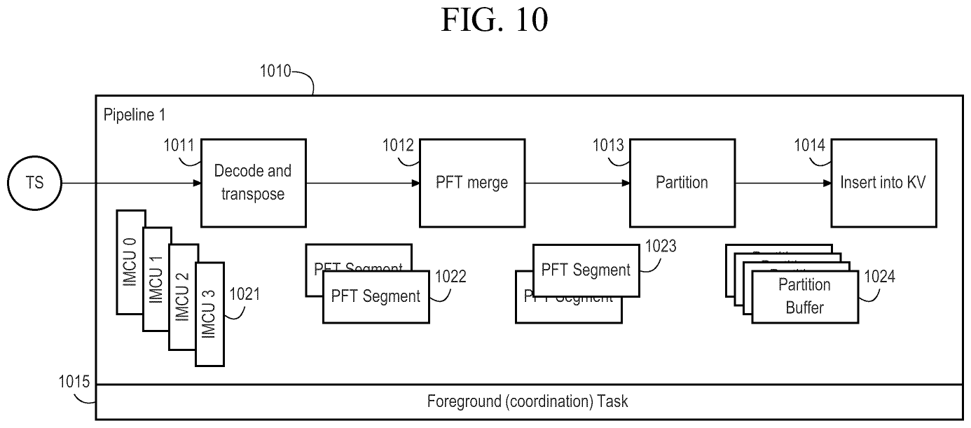

FIG. 10 illustrates an example pipeline consisting of tasks in accordance with an embodiment. Pipeline 1010 depicts pipeline 1 from FIG. 9. Pipeline 1010 starts with a table scan and includes five logical tasks: decode and transpose 1011, projected flat table (PFT) merge 1012, partition 1013, insert into KV (key value, i.e., the hash table for the join) 1014, and foreground (coordination) task 1015. The table scan pushes data in the form of IMCUs 1021 to the decode and transpose task 1011. Then, decode and transpose task 1011 pushes transpose table segments (PFT segments) 1022 to projected flat table merge task 1012, resulting in projected flat table segments 1023, which are pushed to partition task 1013. Then, the partition task 1013 pushes partition buffers 1024 to the insert into KV task 1014. Thus, the logical tasks 1011-1014 operate on different types of data items.

As described above, each instance of a logical task operating on a data item is a microtask. For example, an instance of decode and transpose task 1011 operating on IMCU 0 is a microtask.

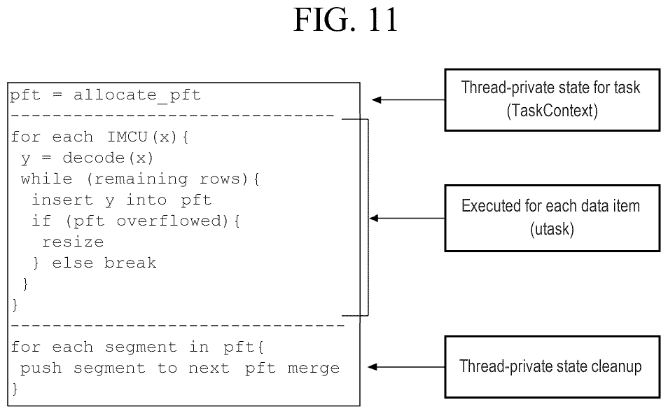

FIG. 11 illustrates an example task in accordance with an embodiment. A Task is a logical entity invoking a sequence of functions (or other utilities or functions) and is instantiated to zero (e.g., it may consume the results of a join that does not yield any matches), one, or many uTasks. A Task consist of three pieces:
Open: create per thread per task context.
Execute: invoked per uTask.
Close: cleanup per thread per task.
   FIG. 11 depicts the decode and transpose task 1011 from FIG. 10. The open portion of the task includes a thread-private state for the task (the task context). The term “task context” may also be referred to as a task-local state, as mentioned above. In the depicted example, the open portion allocates some memory to be used by the thread. The execute portion includes code that is executed for each data item (the uTask). In the depicted example, the execute portion executes a loop for each input (data item). Execution of the loop for a given data item (e.g., an IMCU) is a uTask. In this example, the uTask takes an IMCU, performs a decode operation, inserts the result into a projected flat table segment, and performs a resize operation. The close portion of the task includes the thread-private state cleanup. In the depicted example, the close portion pushes each projected flat table segment to the projected flat table merge logical task.

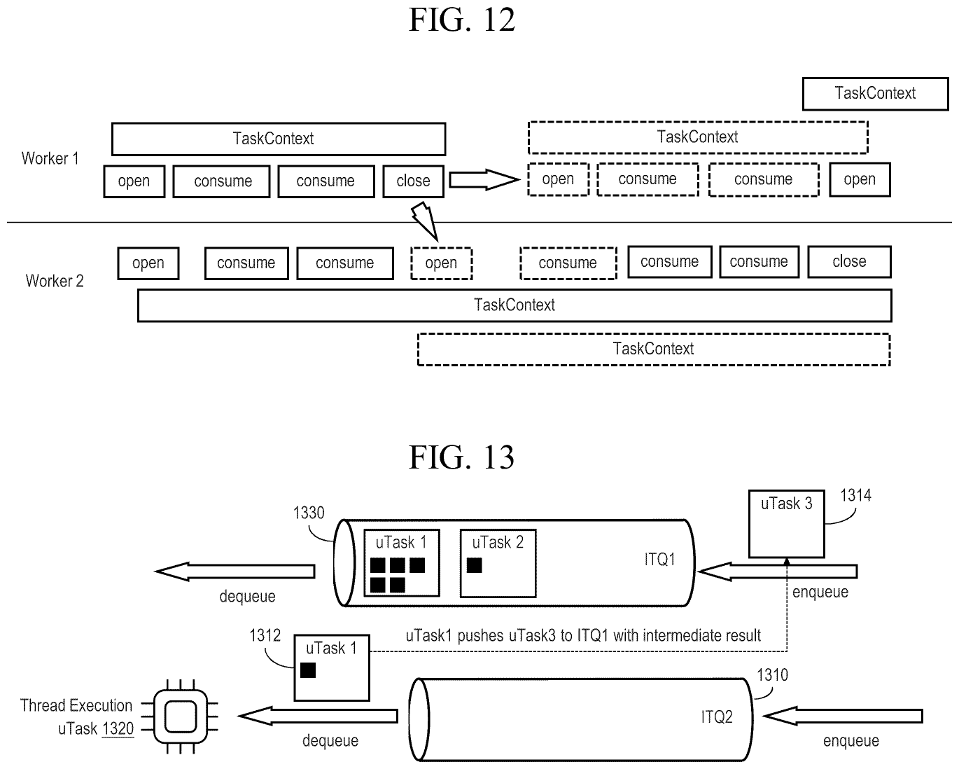

FIG. 12 is a diagram illustrating task-to-microtask scheduling for a compute-offload plan in accordance with an embodiment. In the depicted example, the blocks with a solid line correspond to the decode and transpose logical task 1011 (referred to as Task 1 herein) and the blocks with a dotted line correspond to the projected flat table merge logical task 1012 (Task 2 herein) in FIG. 10. Task 1 is as shown in FIG. 11. Task 2 (PFT merge) is as follows:
Merge into global_pft
   Multiple tasks can be executed in parallel on threads (worker 1 and worker 2). Each thread can execute one or more uTasks.

The first time a thread sees a uTask for a Task, the first thing it does is open the Task locally. This means that the thread creates a Task context locally. When the Task context is created, the Task can consume data. Each “consume” block represents a uTask. Thus, Worker 1 opens Task 1, creates a Task 1 context, consumes data items (i.e., executes two uTasks), and closes Task 1. In the example, consuming two IMCUs may generate more than two projected flat table segments, or Task 1 on worker 1 may consume more than two IMCUs. Worker 2 opens Task 1, creates a Task 1 context, and begins consuming data items. Closing Task 1 on worker 1 initiates the cleanup phase, which pushes resulting PFT segments to the PFT merge Task, Task 2, and destroys the task context.

Task 2 depends on Task 1; therefore, it must be scheduled after Task1.close( ). Worker 1 can then open Task 2, create a Task 2 context, and consume data that it received from Task 1. In the example shown in FIG. 12, Task 1 can also push data to Task 2 in the worker 2 thread. Thus, worker 2 also opens Task 2, creates a Task 2 context, and begins consuming data from Task 1.

The dependency between Task 1 and Task 2 is a uTask-level dependency and is based on which task pushes data items to another task. For such a dependency, the push may happen even inside a consume or open. For this specific example, it happens that Task 1 is pushing data items during the TaskContext close, but there is a difference between a TaskContext close (when a worker clears up the thread-local task context) and the task close, which would be “finalized” after all relevant task contexts have been cleaned up (right-hand side of FIG. 12). This type of dependency may result in an overlapped execution of Task 1 and Task 2.

Another type of dependency is a “barrier” dependency in which a task depends on another task fully closing. For that to happen, data items for Task 2 would be scheduled only after all TaskContexts for Task 1 are cleaned up. This type of dependency appears between tasks 1012 and 1013 of FIG. 10, and it is implemented by attaching an “after-close” callback to PFT merge. The “after-close” callback will be executed as soon as the last TaskContext for that task is cleaned up (or the task is destroyed without any TaskContexts active/created), and it would push (potentially indirectly through another task) data items to the barrier-dependent Task (1013 in this example). This type of dependency will order all consumes of Task 2 before the first consume of Task 1.

The uTasks from Task 1 and Task 2 can be executed in parallel, because Task 2 is not blocked by Task 1. Also, worker 2 can execute Task 1 uTasks and Task 2 uTasks as long as both Tasks are open. Eventually, worker 2 closes Task 1 and destroys the Task 1 context. Task 1 can resume on either thread. FIG. 12 shows worker 1 re-opening Task 1 and creating a Task 1 context locally. That is, each worker thread can execute uTasks for a Task as long as there is a task context open for that Task and there are data items to consume. A Task can close and reopen on the same worker thread or another worker thread.

Task-Based Execution Scheduling using Inter-Task Queue (ITQ)

When, for example, Task 1 pushes data to Task 2, it creates an entry in an ITQ for Task 2. FIG. 13 illustrates task-based scheduling using inter-task queues in accordance with an embodiment. The task scheduling is done via the ITQ, which tracks the execution of all uTasks for a Task inside a pipeline and acts as a communication medium between uTasks. When all data items (inputs) are enqueued, the ITQ is responsible for tracking the completion of all enqueued tasks, notifying the worker thread to call the close( ) function to clean up task context, and triggering after-close dependency actions, if any. A worker thread may work on multiple uTasks from multiple ITQs.

As shown in FIG. 13, data is enqueued into ITQ2 1310, thus forming uTasks in the ITQ2 1310 of a Task. ITQ2 1310 assigns uTask1 1312 to thread 1320. In the example shown in FIG. 13, uTask1 1312 pushes a uTask3 1314 to ITQ1 1330 with an intermediate result to be consumed by uTasks for another Task. ITQ1 1330 then tracks the execution of all uTasks for that Task and dequeues uTasks to other Tasks or dequeues final results.

ITQs may be of different types. For a random ITQ, an enqueued task has no special tagging. Any thread can pick up any task at any time. For example, a Task for decoding and transposing IMCU data can have a random ITQ. For a partition ITQ, there can be at most one active task per partition at a time by any thread. For example, a Task that partitions data to send to different eNodes can have a partition ITQ. As another example, for a multi-threaded KV insert with partition buffers, the ITQ can only schedule one task per partition, and no KV locking is needed. An in-place ITQ runs on the RDBMS only. This ITQ is usually a pass-through, and the same thread enqueues and dequeues directly. A completion ITQ is dequeued by the RDBMS foreground threads to invoke row procedure.

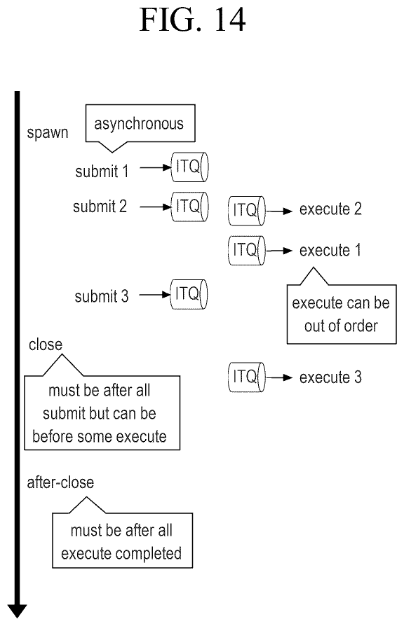

FIG. 14 illustrates inter-task queue operations in accordance with an embodiment. The following operations are performed for an ITQ:
Spawn: this operation creates an ITQ and specifies inputs for task context creation.
Submit (enqueue work item): this operation can be performed by any entity that has the ITQ reference (e.g., enqueues to a worker pool).
Execute (consume work item): this operation executes the uTask and afterwards notifies that the item is consumed. If needed, it may create a task context (e.g., first invocation).
Close (close entry): this operation signifies no more work items (uTasks) will be submitted.
After-close (after all pending uTasks completed): this operation executes for the after-close callback attached to the ITQ after all uTasks are executed and all TaskContexts for this ITQ are cleaned up.

In the example shown in FIG. 14, the spawn operation creates an ITQ, and multiple submit operations enqueue work items for execution. The submit operations are asynchronous. In some embodiments, there is a submit operation for each uTask. There are also multiple execute operations, which can be executed out of order. Each execute operation corresponds to a uTask. An execute operation can result in work being performed by a worker thread on an eNode or a cNode, depending on whether the plan is offloaded or onloaded or whether the task is executed by a foreground thread. The close operation must be after all submit operations but can be before some execute operations. The after-close operation must be after all execute operations have been completed.

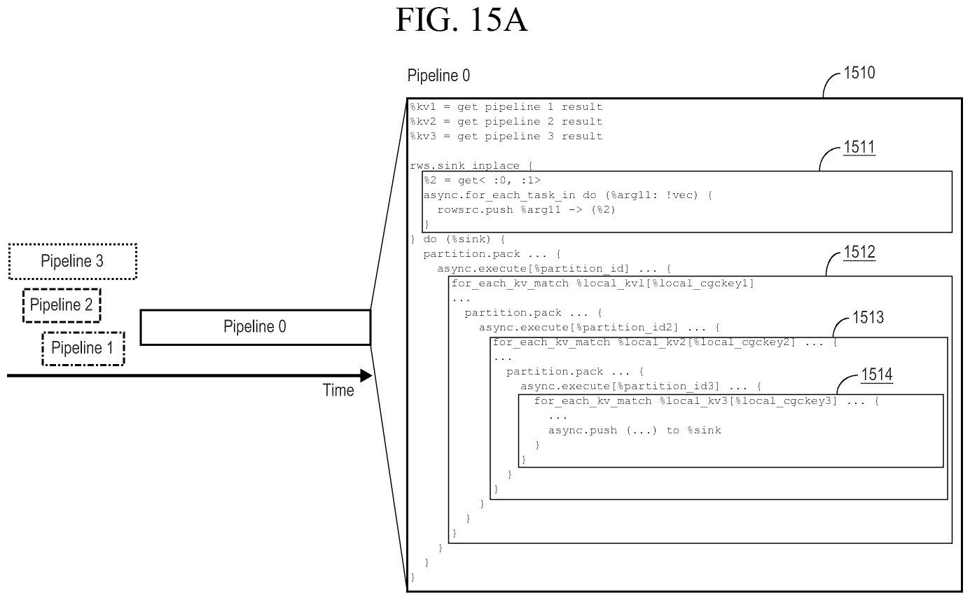

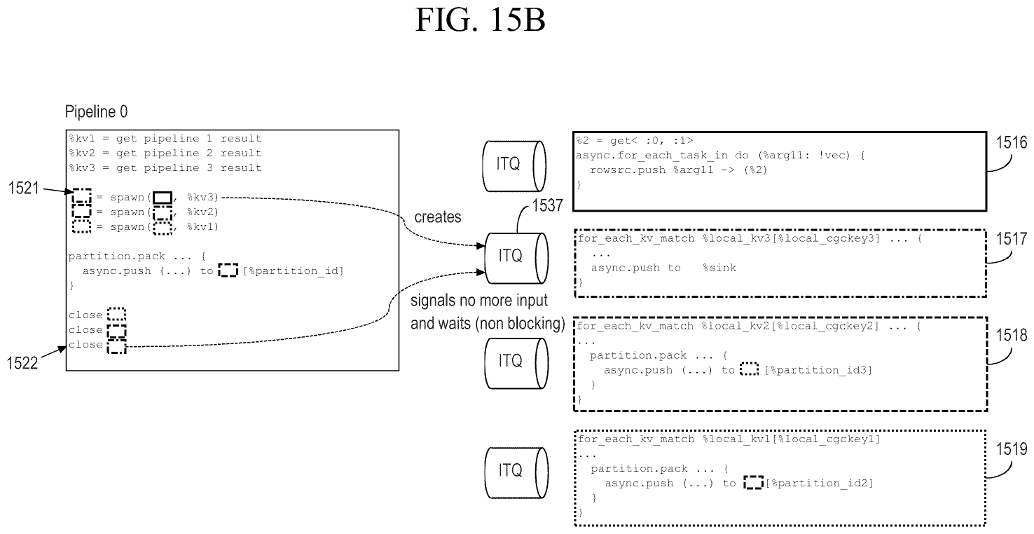

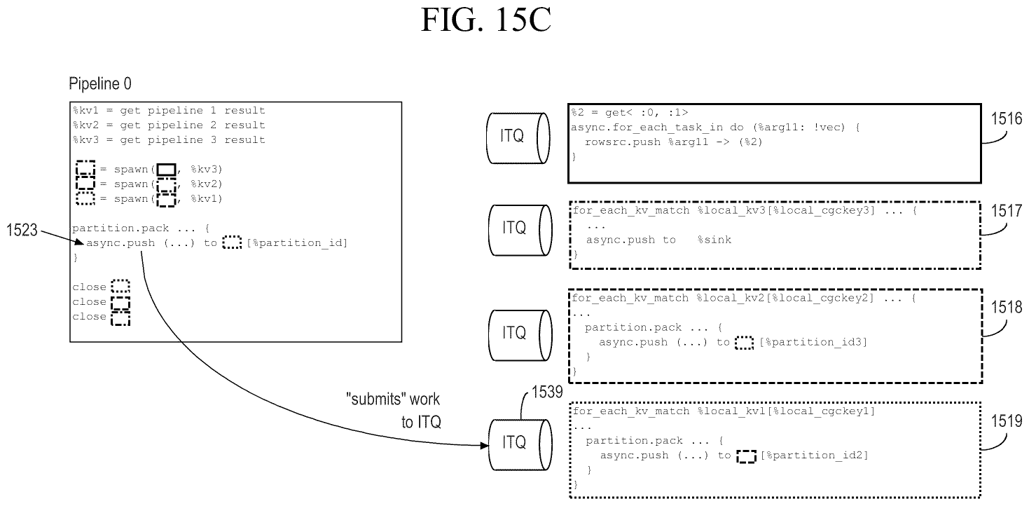

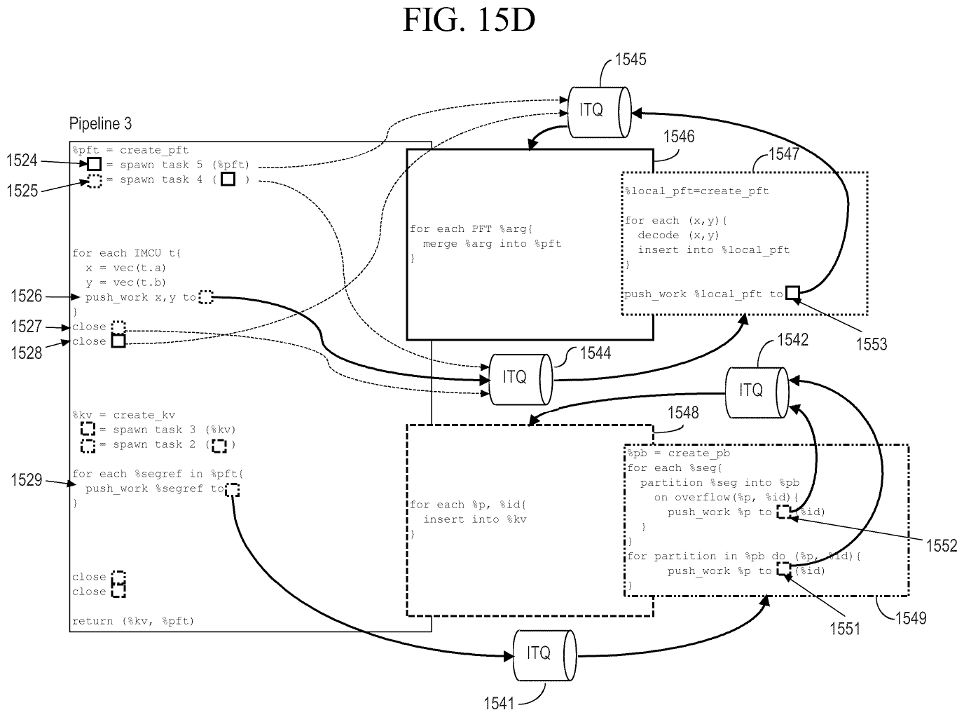

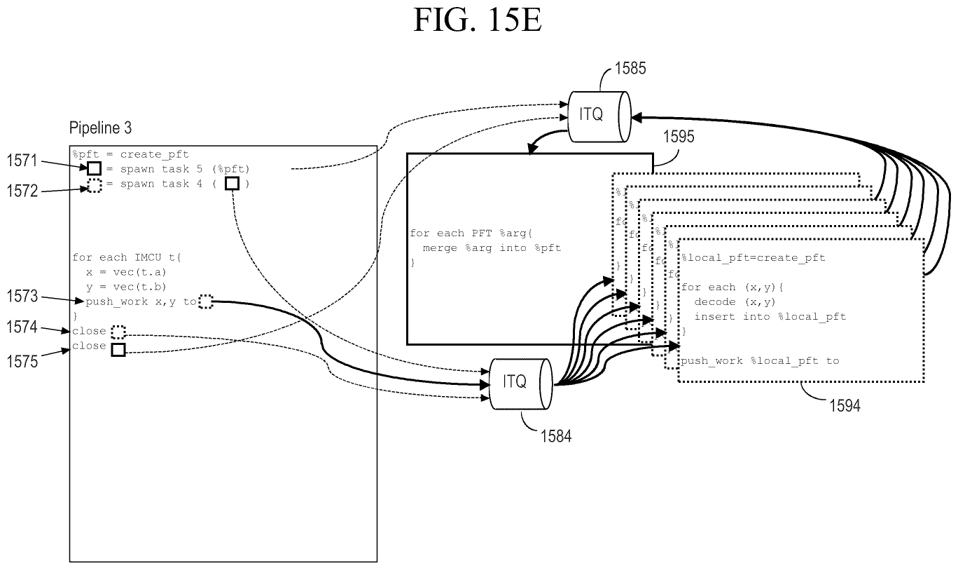

FIG. 15A illustrates mapping operators to high-performance kernel functions inside a pipeline in accordance with an embodiment. The example shown in FIG. 15A refers to the pipelines shown in FIG. 9. Note that pipeline 1, pipeline 2, and pipeline 3 can be executed in parallel; however, pipeline 0 is dependent on pipelines 1-3 and must wait for all work to be completed by pipelines 1-3 before executing.

Code 1510 corresponds to pipeline 0. Each box represents a different Task with a different ITQ. Code 1510 is the initial pass. In one embodiment, code 1510 is for a Task that is associated with an in-place ITQ. Code 1510 will spawn other ITQs for tasks 1511-1514. These ITQs will execute in other threads. In one embodiment, Task 1511 is associated with a completion ITQ. Task 1511 runs in the foreground, and Task 1514 would send results back to Task 1511.

FIG. 15B illustrates extracting asynchronous regions to tasks inside a pipeline in accordance with an embodiment. FIG. 15B depicts the code for pipeline 0 after a transformation that extracts the asynchronous regions (Tasks) 1516-1519, corresponding to tasks 1511-1514, so they are easier to execute. The code for pipeline 0 now includes code for spawning the ITQs, one per asynchronous region 1516-1519. For example, instruction 1521 creates ITQ 1537 for asynchronous region 1517, and instruction 1522 closes ITQ 1537. Closing ITQ 1537 signals that there will be no more input and waits (nonblocking).

FIG. 15C illustrates a microtask enqueueing to another microtask inside a pipeline in accordance with an embodiment. Instruction 1523 pushes (submits) data to ITQ 1538 for consumption by asynchronous code regions (Task) 1519. Note that data is pushed based on a partition identifier. Thus, ITQ 1539 is a partition ITQ. Pushing data may involve sending data to the eNode or cNode executing the ITQ or may involve sending a reference to data already present at the eNode or cNode (e.g., a KV table).

FIG. 15D illustrates multi-task dependencies inside a pipeline in accordance with an embodiment. FIG. 15D shows a more complex execution for pipeline 3 with multiple Tasks and workers. Instruction 1524 creates ITQ 1545. Instruction 1525 creates ITQ 1544. Instruction 1526 pushes data to ITQ 1544, which corresponds to Task 1547. Task 1547 has a cleanup phase that pushes data to ITQ 1545 at 1553. ITQ 1545 corresponds to Task 1546. When all data has been submitted to ITQ 1544, instruction 1527 closes ITQ 1544, and instruction 1528 closes ITQ 1545. Note that the ITQs are closed in the opposite order from their creation.

After ITQs 1544, 1545 are closed, pipeline 3 continues execution with operations that depend on the work performed by Tasks 1546, 1547 via ITQs 1544, 1545. Instruction 1529 pushes work to ITQ 1541, which corresponds to Task 1549. Task 1549 pushes work to ITQ 1542 at 1551, 1552. ITQ 1542 corresponds to Task 1548.

FIG. 15E illustrates parallel microtask versus serial task execution inside a pipeline in accordance with an embodiment. Instruction 1571 creates ITQ 1585, which corresponds to Task 1595, and instruction 1572 creates ITQ 1584, which corresponds to ITQ 1594. Instruction 1573 pushes work to ITQ 1584. In this example, ITQ 1584 dequeues data to a plurality of worker threads in parallel. Each data item (uTask) is executed on exactly one worker (i.e., the plurality of worker threads is across data items). The worker threads, executing uTasks for Task 1594, push work to ITQ 1585. When all work has been submitted to ITQ 1584, instruction 1574 closes ITQ 1584. When all work has been submitted to ITQ 1585, instruction 1575 closes ITQ 1585.

### Virtual Connection Group Hiding Local Versus Remote Execution

A virtual connection group (VCG) is an abstraction that encapsulates the network communication logic in the procedure of submitting a task. The offload plan is generated regardless of its intended execution location or the number of participating eNodes. Network connections can be reused across VCGs. For remote or distributed ITQ processing, the VCG is responsible for monitoring the ITQ task execution, e.g., counting the number of submitted uTasks and the number of completed uTasks. The VCG is also responsible for handling out-of-order network message delivery, e.g., a submit operation must be received before a close operation. A VCG is an elastic set whose members must cooperate to execute tasks. There are three types of members: one owner can create a VCG and coordinate task execution, zero or more sender nodes that delegate work execution to another node by sending work to a remote ITQ that resides on a receiver-node, and zero or more receiver nodes that receive that delegated work from remote nodes and submit it to their local (shadow) ITQs for execution. The sender can send work to the ITQ of the task using a reference to the ITQ. The owner can close the ITQ after all the senders have finished sending work to the ITQ and have closed down. A node can have multiple roles. For example, an owner can be a sender, a receiver, or both.

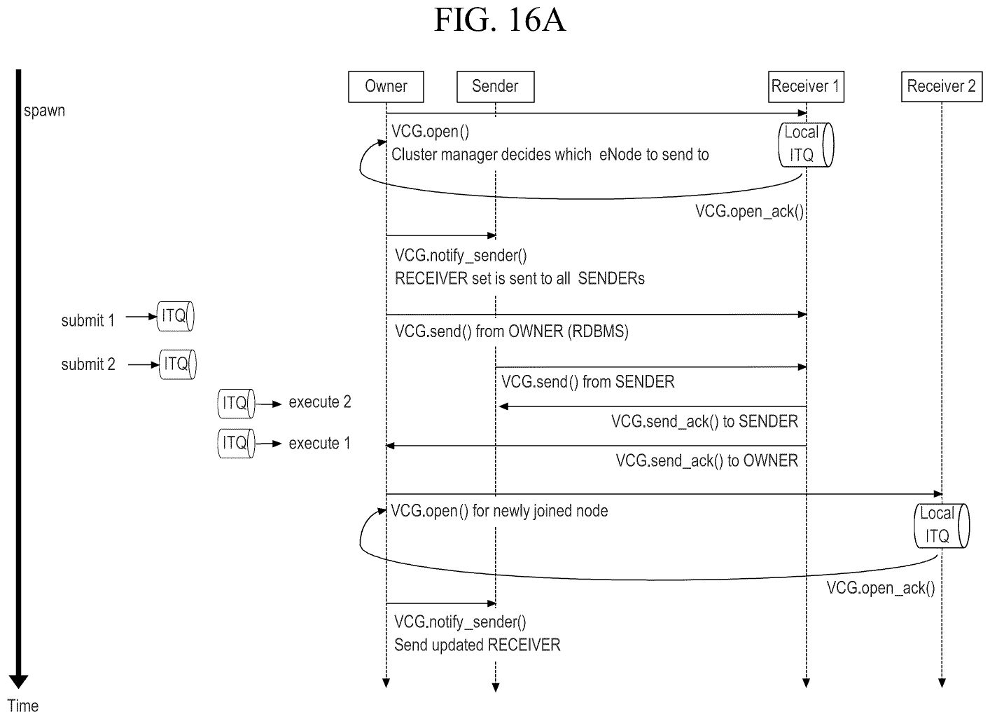

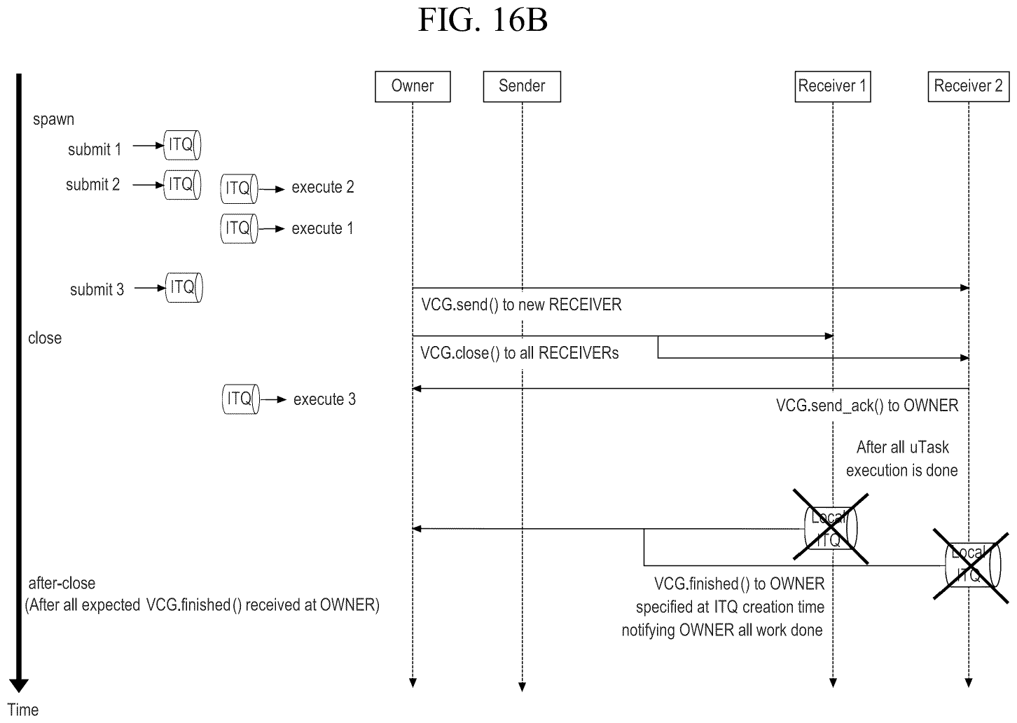

FIGS. 16A and 16B are data flow diagrams illustrating inter-task queue and virtual connection group messaging in accordance with an embodiment. With reference to FIG. 16A, the owner receives a spawn operation for the ITQ and calls VCG.open( ) to instruct receiver 1 to open the VCG. In response, receiver 1 creates the VCG at the receiver node and creates a local ITQ. Receiver 1 then calls VCG.open_ack( ) to send an acknowledgment to the owner that the VCG and ITQ have been opened. The owner calls VCG.notify_sender( ) to send a notification identifying receiver 1 to all senders.

The owner and sender can both call VCG.send( ) to send work to the ITQ at receiver 1. In response, receiver 1 calls VCG.send_ack( ) to send an acknowledgment to the sender and the owner to acknowledge receiving the work.

The owner can also call VCG.open( ) to instruct newly joined receiver node, receiver 2, to open the VCG. In response, receiver 2 creates the VCG at the receiver 2 node and creates a local ITQ. Receiver 2 then calls VCG.open_ack( ) to send an acknowledgment to the owner that the VCG and ITQ have been opened. The owner calls VCG.notify_sender( ) to send a notification identifying receiver 2 to all senders.

Turning to FIG. 16B, the owner can call VCG.send( ) to send work to the new receiver, receiver 2. When all work has been sent, the owner calls VCG.close( ) to instruct all receivers to close the ITQ. In the depicted example, receiver 2 calls VCG.send_ack( ) to send an acknowledgment to the owner to acknowledge receiving the work. As mentioned above, the owner can close the ITQ once all work has been submitted. The receiver can acknowledge receiving the work after the owner has called VCG.close( ).

After all uTask execution is done and VCG.close( ) is received, receiver 1 and receiver 2 destroy their local ITQs and call VCG.finished( ) to notify the owner specified at ITQ creation time that all work has been done. After all expected VCG.finished( ) calls have been received at the owner, the owner can perform after-close operations.

### NUMA-Aware

Tasks are submitted with an optional non-uniform memory access (NUMA) hint. There are three options for NUMA hints:
No hint: any thread may execute the Task.
Soft hint (default): threads on a specified NUMA have higher priority; however, idle threads on other nodes may pick it up.
Hard hint: execution only by threads of the specified NUMA.
   The NUMA hint of the task is automatically added during compute-offload compilation and is originated from the data item, either the input, such as IMCU, or the intermediate data structure, such as KV table. Memory is allocated on local NUMA by default, and the memory pool is also NUMA-aware.

### Compute Offload on Exadata Cell

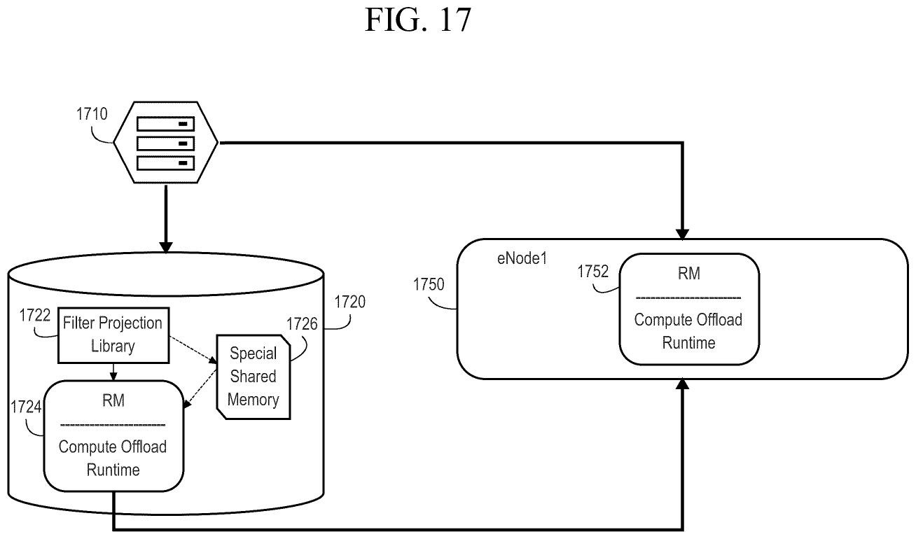

FIG. 17 illustrates compute offload on a storage cell in accordance with an embodiment. An Exadata cell server is the core Exadata system software component responsible for the majority of services provided by storage servers in the Exadata architecture, including SQL offload, I/O resource management (IORM), Exadata remote direct memory access (RDMA) memory (XRMEM) and flash cache tiering, and storage index creation and maintenance. In this embodiment, sNode 1720 is capable of performing Exadata operations, such as smart scan.

In accordance with this embodiment, storage node (sNode) 1720 includes compute-offload runtime 1724, and compute offload can be started from an sNode 1720. RDBMS 1710 communicates some user information to sNode 1720. Thus, data is streamed from RDBMS (cNode) 1710; however, it would save both the memory bandwidth on the cNode and computer-storage network if sNode 1720 can send data directly to eNode1 1750, which includes compute-offload runtime 1752. RDBMS 1710 communicates with Oracle® Exadata libraries, such as filter projection library 1722. The filter projection library 1722 acts as a proxy for the compute-offload instance running on the cell. This functionality depends on whether the sNode is configured to connect with an external network directly.

In accordance with the embodiment, the filter projection library 1722 stores data to a special shared memory 1726, which is accessible by the compute offload runtime 1724. Memory 1726 includes a command region and a data region. The command region controls message exchange between the library 1722 and compute-offload runtime 1724. The data region stores filtered data to offload. Compute-offload runtime 1724 monitors what data are written to special shared memory 1726. If new data arrives in special shared memory 1726, compute-offload runtime 1724 will know based on metadata where this data should be sent. Thus, compute-offload runtime 1724 can send the data to eNode1 1750 for execution.

In this embodiment, sNode 1720 can perform a smart scan and generate filtered data. sNode 1720 can store the filtered data in special shared memory 1726, and compute-offload runtime 1724 can send the filtered data to eNode1 1750 for offload execution via compute-offload runtime 1752. Compute-offload runtime 1724 is responsible for communication. RDBMS cNode 1710 orchestrates the entire execution, as described above. Compute-offload runtime 1724 does the data transfer and nothing else.

### Procedural Overview

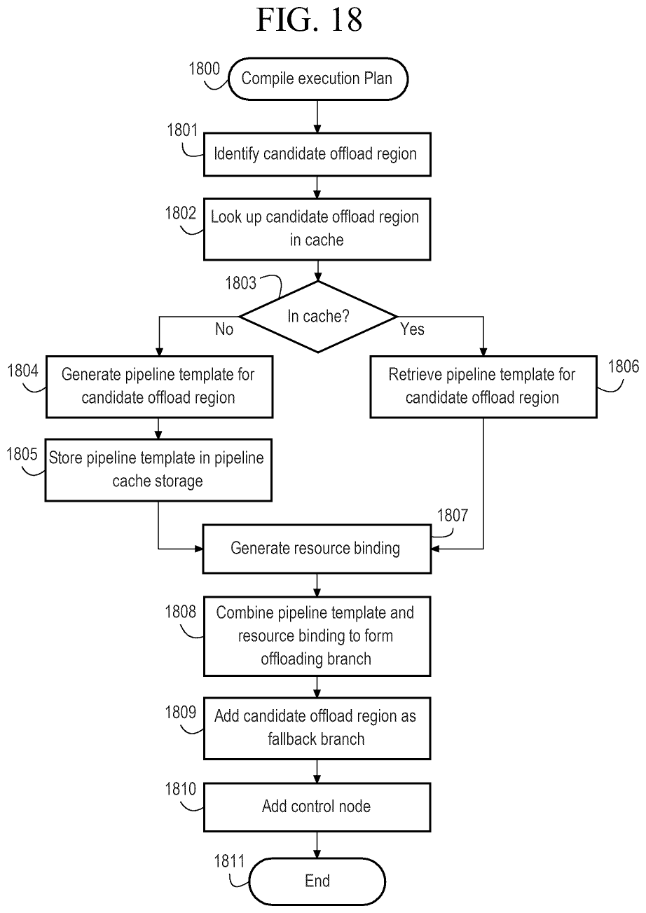

FIG. 18 is a flowchart illustrating compiling an execution plan for compute offload with fallback in accordance with an embodiment. Operation begins for the compilation of an execution plan (block 1800), and the RDBMS identifies a candidate offload region (block 1801). The RDBMS looks up the candidate offload region in a pipeline cache storage (block 1802). Looking up the candidate offload region of the execution plan in the pipeline cache storage may comprise matching the portion of the execution plan to each pipeline template in the pipeline cache storage based on one or more of: operations performed in the portion of the execution plan, data item types referenced in the portion of the execution plan, or number of columns referenced in the portion of the execution plan. The RDBMS determines whether there is an entry for the candidate offload region in the pipeline cache storage (block 1803).

If the candidate offload region is not found in the pipeline cache storage (cache miss) (block 1803:No), then the RDBMS generates a pipeline template for the candidate offload region (block 1804) and stores the pipeline template in the pipeline cache storage (block 1805). If the candidate offload region is found in the pipeline cache storage (cache hit) (block 1803:Yes), then the RDBMS retrieves the pipeline template for the candidate offload region (block 1806).

Thereafter, the RDBMS generates a resource binding for the pipeline template (block 1807). The RDBMS combines the pipeline template and the resource binding to form an offloading branch (block 1808). The RDBMS also adds the original candidate offload region as a fallback branch (block 1809) and adds a control node to determine whether to execute the compute-offload branch using the compute-offload runtime or the fallback branch using the RDBMS (block 1810). Thereafter, the operation ends (block 1811).

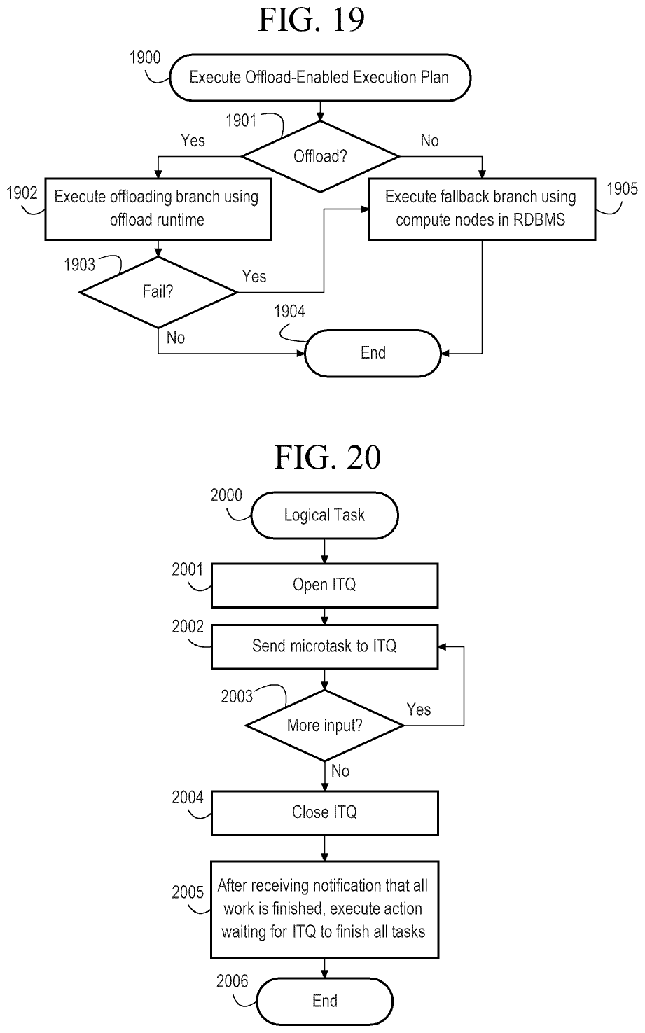

FIG. 19 is a flowchart illustrating executing an offload-enabled execution plan in accordance with an embodiment. Operation begins for executing an offload-enabled execution plan (block 1900). The RDBMS determines whether to offload execution (block 1901). In one embodiment, the RDBMS determines whether the compute offload server has a resource limitation at row source allocation time. If the RDBMS determines to offload the execution (block 1901:Yes), then the RDBMS initiates execution of the offloading branch using a compute-offload runtime (block 1902). The RDBMS determines if the execution of the offloading branch fails (block 1903). If the RDBMS determines that the execution of the offloading branch has not failed (block 1902:No), then the operation ends (block 1904).

If the RDBMS determines not to offload execution (block 1901:No), then the RDBMS executes the fallback branch using compute nodes in the RDBMS (block 1905). Also, if the RDBMS determines that execution of the offloading branch fails (block 1903:Yes), then the RDBMS can execute the fallback branch using one or more compute nodes in the database server (block 1905). Thereafter, the operation ends (block 1904).

FIG. 20 is a flowchart illustrating executing a logical task in accordance with an embodiment. Operation begins for a logical task (block 2000). The compute-offload runtime opens an inter-task queue (ITQ) (block 2001) and sends a microtask to the ITQ (block 2002). A microtask is an instance of the task for a data item. The compute-offload runtime determines whether there is more input (block 2003). If there is more input (block 2003:Yes), then the operation returns to block 2002 to send a microtask to the ITQ.

If there is no more input (block 2003:No), then the compute-offload runtime closes the ITQ (block 2004). After receiving notification that all work is finished, the compute-offload runtime executes zero or more actions waiting for the ITQ to finish all tasks (block 2005). Thereafter, the operation ends (block 2006).

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

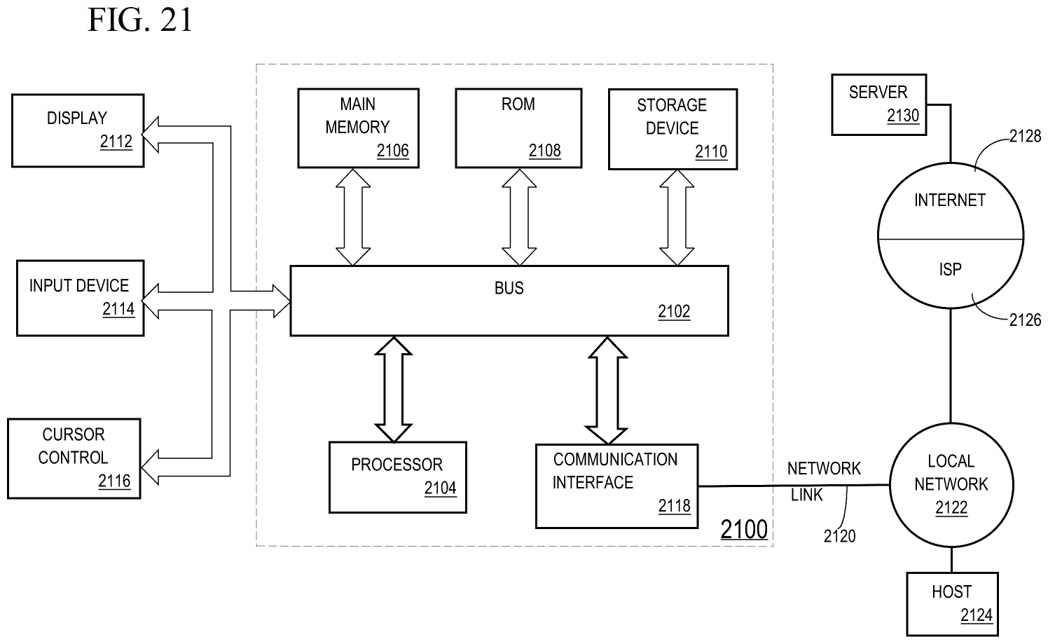

For example, FIG. 21 is a block diagram that illustrates a computer system 2100 upon which the embodiments may be implemented. Computer system 2100 includes a bus 2102 or other communication mechanism for communicating information, and a hardware processor 2104 coupled with bus 2102 for processing information. Hardware processor 2104 may be, for example, a general-purpose microprocessor.

Computer system 2100 also includes a main memory 2106, such as random-access memory (RAM) or another dynamic storage device, coupled to bus 2102 for storing information and instructions to be executed by processor 2104. Main memory 2106 may also be used for storing temporary variables or other intermediate information during the execution of instructions to be executed by processor 2104. Such instructions, when stored in non-transitory storage media accessible to processor 2104, render computer system 2100 into a special-purpose machine that is customized to perform the operations specified in the instructions.

Computer system 2100 further includes a read only memory (ROM) 2108 or other static storage device coupled to bus 2102 for storing static information and instructions for processor 2104. A storage device 2110, such as a magnetic disk, optical disk, or solid-state drive is provided and coupled to bus 2102 for storing information and instructions.

Computer system 2100 may be coupled via bus 2102 to a display 2112, such as a cathode ray tube (CRT), for displaying information to a computer user. An input device 2114, including alphanumeric and other keys, is coupled to bus 2102 for communicating information and command selections to processor 2104. Another type of user input device is cursor control 2116, such as a mouse, a trackball, or cursor direction keys for communicating direction information and command selections to processor 2104 and for controlling cursor movement on display 2112. This input device typically has two degrees of freedom in two axes, a first axis (e.g., x) and a second axis (e.g., y), that allows the device to specify positions in a plane.

Computer system 2100 may implement the techniques described herein using customized hard-wired logic, one or more ASICs or FPGAs, firmware, and/or program logic which, in combination with the computer system, causes or programs computer system 2100 to be a special-purpose machine. According to one embodiment, the techniques herein are performed by computer system 2100 in response to processor 2104 executing one or more sequences of one or more instructions contained in main memory 2106. Such instructions may be read into main memory 2106 from another storage medium, such as storage device 2110. Execution of the sequences of instructions contained in main memory 2106 causes processor 2104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 2110. Volatile media includes dynamic memory, such as main memory 2106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 2102. Transmission media can also take the form of acoustic or light waves, such as those generated during radio-wave and infra-red data communications.

Various forms of media may be involved in carrying one or more sequences of one or more instructions to processor 2104 for execution. For example, the instructions may initially be carried on a magnetic disk or solid-state drive of a remote computer. The remote computer can load the instructions into its dynamic memory and send the instructions over a telephone line using a modem. A modem local to computer system 2100 can receive the data on the telephone line and use an infra-red transmitter to convert the data to an infra-red signal. An infra-red detector can receive the data carried in the infra-red signal and appropriate circuitry can place the data on bus 2102. Bus 2102 carries the data to main memory 2106, from which processor 2104 retrieves and executes the instructions. The instructions received by main memory 2106 may optionally be stored on storage device 2110 either before or after execution by processor 2104.

Computer system 2100 also includes a communication interface 2118 coupled to bus 2102. Communication interface 2118 provides a two-way data communication coupling to a network link 2120 that is connected to a local network 2122. For example, communication interface 2118 may be an integrated services digital network (ISDN) card, cable modem, satellite modem, or a modem to provide a data communication connection to a corresponding type of telephone line. As another example, communication interface 2118 may be a local area network (LAN) card to provide a data communication connection to a compatible LAN. Wireless links may also be implemented. In any such implementation, communication interface 2118 sends and receives electrical, electromagnetic or optical signals that carry digital data streams representing various types of information.

Network link 2120 typically provides data communication through one or more networks to other data devices. For example, network link 2120 may provide a connection through local network 2122 to a host computer 2124 or to data equipment operated by an Internet Service Provider (ISP) 2126. ISP 2126 in turn provides data communication services through the world wide packet data communication network now commonly referred to as the “Internet” 2128. Local network 2122 and Internet 2128 both use electrical, electromagnetic or optical signals that carry digital data streams. The signals through the various networks and the signals on network link 2120 and through communication interface 2118, which carry the digital data to and from computer system 2100, are example forms of transmission media.

Computer system 2100 can send messages and receive data, including program code, through the network(s), network link 2120 and communication interface 2118. In the Internet example, a server 2130 might transmit a requested code for an application program through Internet 2128, ISP 2126, local network 2122 and communication interface 2118.

The received code may be executed by processor 2104 as it is received and/or stored in storage device 2110 or other non-volatile storage for later execution.

### Software Overview

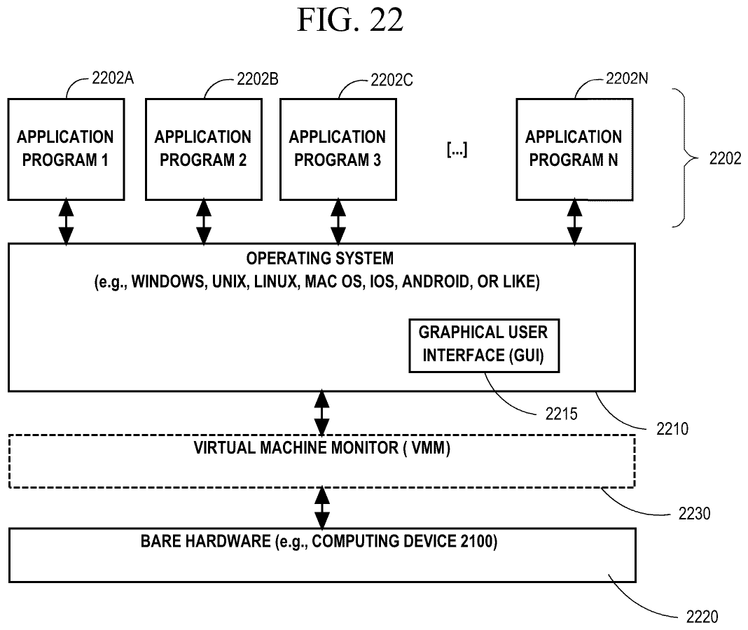

FIG. 22 is a block diagram of a basic software system 2200 that may be employed for controlling the operation of computer system 2100. Software system 2200 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 2200 is provided for directing the operation of computer system 2100. Software system 2200, which may be stored in system memory (RAM) 2106 and on fixed storage (e.g., hard disk or flash memory) 2110, includes a kernel or operating system (OS) 2210.

The OS 2210 manages low-level aspects of computer operation, including managing execution of processes, memory allocation, file input and output (I/O), and device I/O. One or more application programs, represented as 2202A, 2202B, 2202C . . . 2202N, may be “loaded” (e.g., transferred from fixed storage 2110 into memory 2106) for execution by system 2200. The applications or other software intended for use on computer system 2100 may also be stored as a set of downloadable computer-executable instructions, for example, for downloading and installation from an Internet location (e.g., a Web server, an app store, or other online service).

Software system 2200 includes a graphical user interface (GUI) 2215, for receiving user commands and data in a graphical (e.g., “point-and-click” or “touch gesture”) fashion. These inputs, in turn, may be acted upon by system 2200 in accordance with instructions from operating system 2210 and/or application(s) 2202. The GUI 2215 also serves to display the results of operation from the OS 2210 and application(s) 2202, whereupon the user may supply additional inputs or terminate the session (e.g., log off).

OS 2210 can execute directly on the bare hardware 2220 (e.g., processor(s) 2104) of computer system 2100. Alternatively, a hypervisor or virtual machine monitor (VMM) 2230 may be interposed between the bare hardware 2220 and the OS 2210. In this configuration, VMM 2230 acts as a software “cushion” or virtualization layer between the OS 2210 and the bare hardware 2220 of the computer system 2100.

VMM 2230 instantiates and runs one or more virtual machine instances (“guest machines”). Each guest machine comprises a “guest” operating system, such as OS 2210, and one or more applications, such as application(s) 2202, designed to execute on the guest operating system. The VMM 2230 presents the guest operating systems with a virtual operating platform and manages the execution of the guest operating systems.

In some instances, the VMM 2230 may allow a guest operating system to run as if it is running on the bare hardware 2220 of computer system 2200 directly. In these instances, the same version of the guest operating system configured to execute on the bare hardware 2220 directly may also execute on VMM 2230 without modification or reconfiguration. In other words, VMM 2230 may provide full hardware and CPU virtualization to a guest operating system in some instances.

In other instances, a guest operating system may be specially designed or configured to execute on VMM 2230 for efficiency. In these instances, the guest operating system is “aware” that it executes on a virtual machine monitor. In other words, VMM 2230 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
compiling, by a database system, an execution plan to generate, for at least a portion of the execution plan, a compute-offload plan for execution by a compute-offload runtime executing within a compute-offload platform, wherein:
the compute-offload platform comprises one or more compute nodes of the database system, one or more offload execution nodes of a compute-offload cluster, and one or more storage nodes,
the compute-offload runtime comprises a compute-offload runtime library executing on the one or more compute nodes and on the one or more offload execution nodes, and
the compute-offload plan specifies a set of one or more tasks to be offloaded and metadata specifying resource binding parameter values associating a set of one or more data items stored in the one or more storage nodes with the set of one or more tasks; and
executing, using the compute-offload runtime, the compute-offload plan, comprising:
sending, using a first communication path, the set of one or more tasks and the resource binding parameter values from the database system to the compute-offload cluster;
transferring, using a second communication path, the set of one or more data items from the one or more storage nodes to the one or more offload execution nodes based on the resource binding parameter values; and
executing the set of one or more tasks on the one or more offload execution nodes of the compute-offload cluster to process the set of one or more data items,
wherein the method is performed by one or more computing devices.

2. The method of claim 1, wherein executing the set of one or more tasks comprises generating a set of results and wherein executing the compute-offload plan further comprises transferring the set of results from the one or more offload execution nodes to the database system using the first communication path.

3. The method of claim 1, wherein:
the one or more storage nodes comprise a load balancer, and
transferring the set of one or more data items comprises distributing the data items to the one or more offload execution nodes according to an initial data distribution determined by the load balancer.

4. The method of claim 3, wherein the compute-offload cluster comprises a second load balancer, the method further comprising:
monitoring, by the second load balancer, a distribution of data among the one or more offload execution nodes during execution of the compute-offload plan; and
performing data shuffling among the one or more offload execution nodes based on a data distribution determined by the second load balancer.

5. The method of claim 3, wherein the initial data distribution comprises a random distribution or a partition distribution.

6. The method of claim 1, wherein the second communication path comprises a direct connection between the one or more storage nodes and the compute-offload cluster.

7. The method of claim 1, wherein transferring, using the second communication path, the set of one or more data items from the one or more storage nodes to the one or more offload execution nodes comprises:
reading the set of one or more data items from the one or more storage nodes into one or more compute nodes of the database system; and
transferring the one or more data items from the one or more compute nodes to the one or more offload execution nodes.

8. The method of claim 1, wherein transferring, using the second communication path, the set of one or more data items from the one or more storage nodes to the one or more offload execution nodes comprises:
executing, by the one or more storage nodes, a filter operation on the one or more data items to generate filtered data; and
transmitting the filtered data from the one or more storage nodes to the compute-offload cluster.

9. The method of claim 8, wherein:
the one or more storage nodes execute a filter projection library and a storage offload runtime library,
the filter projection library performs the filter operation and stores the filtered data in a shared memory that is shared by the filter projection library and the storage offload runtime library, and
the storage offload runtime library transmits the filtered data from the shared memory to the compute-offload cluster.

10. The method of claim 1, wherein the one or more data items comprise one or more of:
one or more column-level data structures,
one or more row-level data structures,
one or more vector data structures.

11. One or more non-transitory computer-readable media storing instructions which, when executed by one or more processors, cause:
compiling, by a database system, an execution plan to generate, for at least a portion of the execution plan, a compute-offload plan for execution by a compute-offload runtime executing within a compute-offload platform, wherein:
the compute-offload platform comprises one or more compute nodes of the database system, one or more offload execution nodes of a compute-offload cluster, and one or more storage nodes,
the compute-offload runtime comprises a compute-offload runtime library executing on the one or more compute nodes and on the one or more offload execution nodes, and
the compute-offload plan specifies a set of one or more tasks to be offloaded and metadata specifying resource binding parameter values associating a set of one or more data items stored in the one or more storage nodes with the set of one or more tasks; and
executing, using the compute-offload runtime, the compute-offload plan, comprising:
sending, using a first communication path, the set of one or more tasks and the resource binding parameter values from the database system to the compute-offload cluster;
transferring, using a second communication path, the set of one or more data items from the one or more storage nodes to the one or more offload execution nodes based on the resource binding parameter values; and
executing the set of one or more tasks on the one or more offload execution nodes of the compute-offload cluster to process the set of one or more data items.

12. The one or more non-transitory computer-readable media of claim 11, wherein executing the set of one or more tasks comprises generating a set of results and wherein executing the compute-offload plan further comprises transferring the set of results from the one or more offload execution nodes to the database system using the first communication path.

13. The one or more non-transitory computer-readable media of claim 11, wherein:
the one or more storage nodes comprise a load balancer, and
transferring the set of one or more data items comprises distributing the data items to the one or more offload execution nodes according to an initial data distribution determined by the load balancer.

14. The one or more non-transitory computer-readable media of claim 13, wherein the compute-offload cluster comprises a second load balancer, wherein the instructions further cause:
monitoring, by the second load balancer, a distribution of data among the one or more offload execution nodes during execution of the compute-offload plan; and
performing data shuffling among the one or more offload execution nodes based on a data distribution determined by the second load balancer.

15. The one or more non-transitory computer-readable media of claim 13, wherein the initial data distribution comprises a random distribution or a partition distribution.

16. The one or more non-transitory computer-readable media of claim 11, wherein the second communication path comprises a direct connection between the one or more storage nodes and the compute-offload cluster.

17. The one or more non-transitory computer-readable media of claim 11, wherein transferring, using the second communication path, the set of one or more data items from the one or more storage nodes to the one or more offload execution nodes comprises:
reading the set of one or more data items from the one or more storage nodes into one or more compute nodes of the database system; and
transferring the one or more data items from the one or more compute nodes to the one or more offload execution nodes.

18. The one or more non-transitory computer-readable media of claim 11, wherein transferring, using the second communication path, the set of one or more data items from the one or more storage nodes to the one or more offload execution nodes comprises:
executing, by the one or more storage nodes, a filter operation on the one or more data items to generate filtered data; and
transmitting the filtered data from the one or more storage nodes to the compute-offload cluster.

19. The one or more non-transitory computer-readable media of claim 18, wherein:
the one or more storage nodes execute a filter projection library and a storage offload runtime library,
the filter projection library performs the filter operation and stores the filtered data in a shared memory that is shared by the filter projection library and the storage offload runtime library, and
the storage offload runtime library transmits the filtered data from the shared memory to the compute-offload cluster.

20. The one or more non-transitory computer-readable media of claim 11, wherein the one or more data items comprise one or more of:
one or more column-level data structures,
one or more row-level data structures,
one or more vector data structures.
